(19) United States
(12) Patent Application Publication
(10) Pub. No.: US 2025/0183941 A1
(43) Pub. Date: Jun. 5, 2025

(54) ENHANCED JOINT TRANSMISSION INCLUDING NON-COHERENT AND COHERENT JOINT TRANSMISSION

(71) Applicant: QUALCOMM Incorporated, San Diego, CA (US)

(72) Inventors: Yi Huang, San Diego, CA (US); Yu Zhang, San Diego, CA (US); Hyojin Lee, San Diego, CA (US); Jing Dai, Beijing (CN); Kexin Xiao, Shanghai (CN)

(21) Appl. No.: 18/842,244

(22) PCT Filed: Apr. 29, 2022
(86) PCT No.: PCT/CN2022/090623

§ 371 Date: Aug. 28, 2024

(51) Int. Cl. H04B 7/024; H04L 5/00

(52) U.S. Cl. CPC H04B 7/024; H04L 5/0051

(57) ABSTRACT

This disclosure provides systems, methods, and devices for wireless communication that support joint transmission operations which include non-coherent and coherent joint transmissions. In a first aspect, an apparatus includes at least one processor and a memory coupled to the at least one processor. The at least one processor is configured receive an indication of channel state information (CSI) reference signal (RS) (CSI-RS) resources and transmit a CSI report based on the CSI resources. The CSI report includes precoding information and channel quality information. The at least one processor is configured to receive an indication of a joint transmission including a non-coherent joint transmission and a coherent joint transmission. The at least one processor is configured to receive the joint transmission corresponding to the indication. Other aspects and features are also claimed and described.

### TECHNICAL FIELD

Aspects of the present disclosure relate generally to wireless communication systems, and more particularly, to joint transmissions. Some features may enable and provide improved communications, including mixed type joint transmissions including a non-coherent joint transmission and a coherent joint transmission.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes receiving an indication of channel state information (CSI) reference signal (RS) (CSI-RS) resources and transmitting a CSI report based on the CSI resources. The CSI report includes precoding information and channel quality information. The method includes receiving an indication of a joint transmission including a non-coherent joint transmission and a coherent joint transmission. The method includes receiving the joint transmission corresponding to the indication. The joint transmission includes the non-coherent joint transmission and the coherent joint transmission, and the joint transmission is based on the precoding information included in the CSI report.

In an additional aspect of the disclosure, an apparatus includes at least one processor and a memory coupled to the at least one processor. The at least one processor is configured to receive an indication of channel state information (CSI) reference signal (RS) (CSI-RS) resources and transmit a CSI report based on the CSI resources. The CSI report includes precoding information and channel quality information. The at least one processor is configured to receive an indication of a joint transmission including a non-coherent joint transmission and a coherent joint transmission. The at least one processor is configured to receive the joint transmission corresponding to the indication. The joint transmission includes the non-coherent joint transmission and the coherent joint transmission, and the joint transmission is based on the precoding information included in the CSI report.

In an additional aspect of the disclosure, an apparatus includes means for receiving an indication of channel state information (CSI) reference signal (RS) (CSI-RS) resources and means for transmitting a CSI report based on the CSI resources. The CSI report includes precoding information and channel quality information. The apparatus includes means for receiving an indication of a joint transmission including a non-coherent joint transmission and a coherent joint transmission. The apparatus includes means for receiving the joint transmission corresponding to the indication. The joint transmission includes the non-coherent joint transmission and the coherent joint transmission, and the joint transmission is based on the precoding information included in the CSI report.

In an additional aspect of the disclosure, a non-transitory computer-readable medium stores instructions that, when executed by a processor, cause the processor to perform operations. The operations include receiving an indication of channel state information (CSI) reference signal (RS) (CSI-RS) resources and transmitting a CSI report based on the CSI resources. The CSI report includes precoding information and channel quality information. The operations include receiving an indication of a joint transmission including a non-coherent joint transmission and a coherent joint transmission. The operations include receiving the joint transmission corresponding to the indication. The joint transmission includes the non-coherent joint transmission and the coherent joint transmission, and the joint transmission is based on the precoding information included in the CSI report.

In another aspect of the disclosure, a method for wireless communication includes transmitting an indication of channel state information (CSI) reference signal (RS) (CSI-RS) resources and receiving a CSI report based on the CSI resources. The CSI report includes precoding information and channel quality information. The method includes transmitting an indication of a joint transmission which includes a non-coherent joint transmission and a coherent joint transmission. The method includes transmitting at least one portion of the joint transmission based on the precoding information and the channel quality information. The at least one portion includes a portion of the non-coherent joint transmission, a portion of the coherent joint transmission, or both.

In an additional aspect of the disclosure, an apparatus includes at least one processor and a memory coupled to the at least one processor. The at least one processor is configured to transmit an indication of channel state information (CSI) reference signal (RS) (CSI-RS) resources and receive a CSI report based on the CSI resources. The CSI report includes precoding information and channel quality information. The at least one processor is configured to transmit an indication of a joint transmission including a non-coherent joint transmission and a coherent joint transmission. The at least one processor is configured to transmit at least one portion of the joint transmission based on the precoding information and the channel quality information. The at least one portion includes a portion of the non-coherent joint transmission, a portion of the coherent joint transmission, or both.

In an additional aspect of the disclosure, an apparatus includes means for transmitting an indication of channel state information (CSI) reference signal (RS) (CSI-RS) resources and means for receiving a CSI report based on the CSI resources. The CSI report includes precoding information and channel quality information. The apparatus includes means for transmitting an indication of a joint transmission including a non-coherent joint transmission and a coherent joint transmission. The apparatus includes means for transmitting at least one portion of the joint transmission based on the precoding information and the channel quality information. The at least one portion includes a portion of the non-coherent joint transmission, a portion of the coherent joint transmission, or both.

In an additional aspect of the disclosure, a non-transitory computer-readable medium stores instructions that, when executed by a processor, cause the processor to perform operations. The operations include transmitting an indication of channel state information (CSI) reference signal (RS) (CSI-RS) resources and receiving a CSI report based on the CSI resources. The CSI report includes precoding information and channel quality information. The operations include transmitting an indication of a joint transmission including a non-coherent joint transmission and a coherent joint transmission. The operations include transmitting at least one portion of the joint transmission based on the precoding information and the channel quality information. The at least one portion includes a portion of the non-coherent joint transmission, a portion of the coherent joint transmission, or both.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIGS. 3A and 3B are block diagrams illustrating an example non-coherent joint transmission and an example of coherent joint transmission according to one or more aspects.

FIGS. 3C and 3D are block diagrams illustrating an example of precoding for non-coherent joint transmission and an example of precoding for coherent joint transmission according to one or more aspects.

FIG. 4 is a block diagram illustrating an example wireless communication system that supports mixed type joint transmissions including a non-coherent joint transmission and a coherent joint transmission according to one or more aspects.

FIG. 5 is timing diagram that supports CSI report operations for mixed type joint transmissions according to one or more aspects.

FIGS. 6A-6C are block diagrams illustrating examples of mixed type joint transmissions at a TRP level according to one or more aspects.

FIG. 7A-7C are block diagrams illustrating examples of mixed type joint transmissions at a MIMO layer level according to one or more aspects.

FIG. 8 is a block diagram of an example of UE CSI reporting indications for reporting configurations of mixed type joint transmissions according to one or more aspects.

FIG. 9 is a flow diagram illustrating an example process that supports mixed type joint transmissions according to one or more aspects.

FIG. 10 is a flow diagram illustrating another example process that supports mixed type joint transmissions according to one or more aspects.

FIG. 11 is a block diagram of an example UE that supports mixed type joint transmissions according to one or more aspects.

FIG. 12 is a block diagram of an example base station that supports mixed type joint transmissions according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

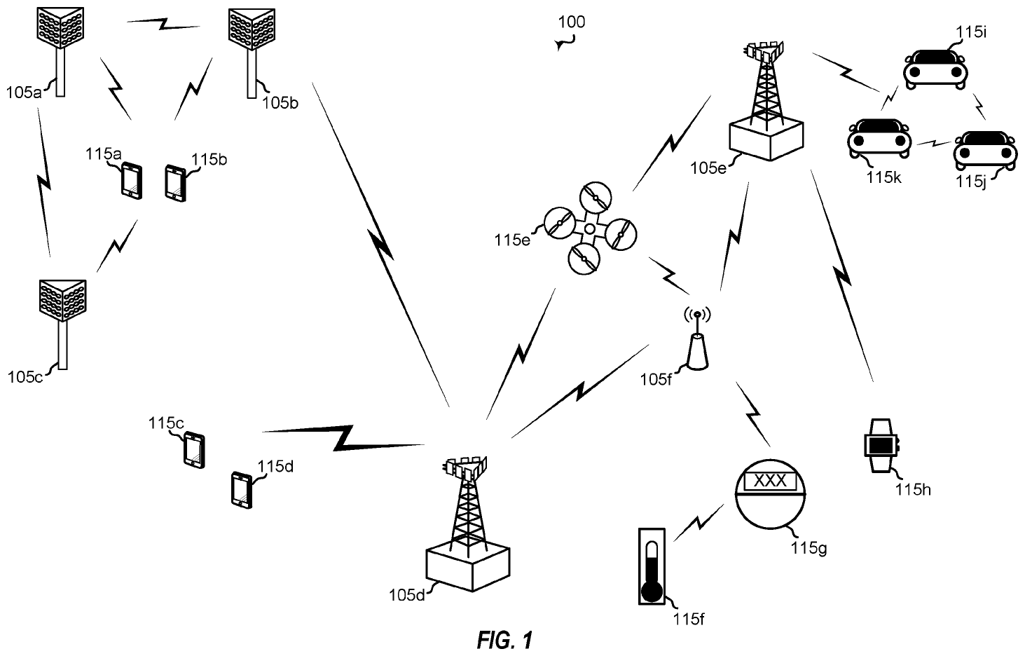

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

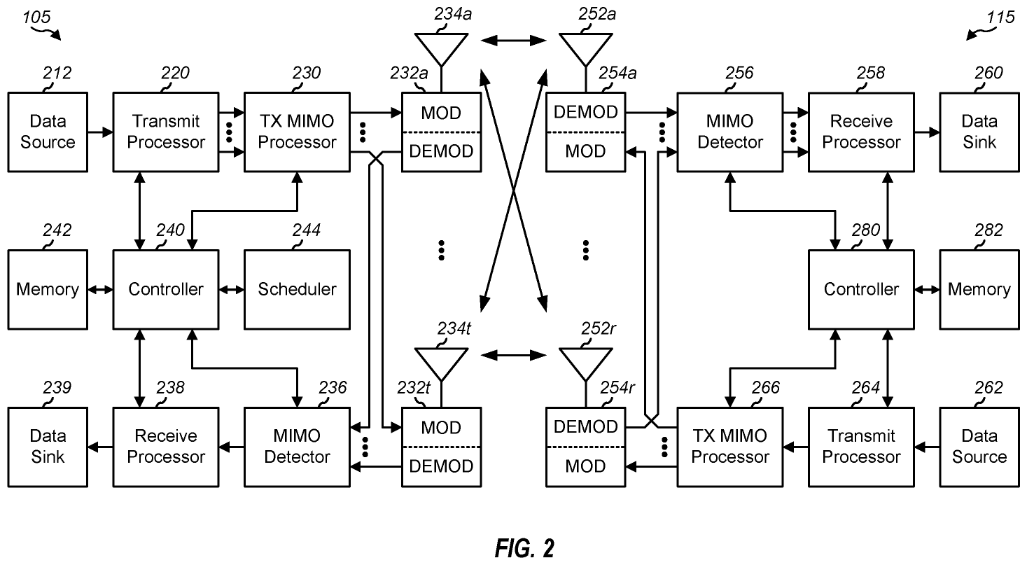

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 1-12, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Joint transmission is the concurrent wireless data transmission from multiple coordinated transmitters to a receiver. In the context of certain wireless networks, an example may include a concurrent wireless data transmission from multiple coordinated nodes to a UE.

Conventional joint transmission includes two types, non-coherent joint transmission and coherent joint transmission. In the case of coherent joint transmission, the network may have knowledge about the detailed channels to the UE from the two or more points involved in the joint transmission, and the network may select transmission weights (precoding information/weights). As an example, the network may focus (e.g., shape or beamform) energy emitted from the two or more transmit points at the position of the device. Thus, coherent joint transmission may be akin to beamforming for which the antennas taking part in the coherent joint transmission are not colocated but correspond to different transmit points (e.g., TRPs).

In contrast, for non-coherent joint transmission, the network may not have certain channel knowledge when performing the joint transmission and each transmit point may transmit their own transmission separately on overlapping resources. Non-coherent joint transmission enables increased power gain by the transmitter transmitting the same signal or enables increase throughput from different transmissions. Non-coherent joint transmission may be more applicable in lower load/usage operating conditions and utilizes less signaling overhead and less complexity as compared to coherent joint transmission. However, coherent joint transmission may offer increased performance such as increased throughput and reduced latency, reduced errors, etc., under certain operations conditions.

Currently, wireless networks utilize joint transmission in a multiple TRP mode limited to two TRPs. In the future, operation with additional TRPs (e.g., more than two) may be possible. However, operations with more than two TRPs may have complex or varying channel conditions between the different TRPs. The varying channel conditions may be suitable for using a joint transmission that includes coherent and non-coherent portions or transmissions. There is currently no support for signaling, measuring, or reporting the information used to enable mixed mode joint transmission, that is a joint transmission including non-coherent and coherent transmissions.

Additionally, current conventional wireless networks utilize a joint transmission mode (non-coherent or coherent) across all layers of a channel. That is, if the channel has or is split into multiple layers, each layer of the channel has the same type and is either coherent or non-coherent. There is no current support for signaling, measuring, or reporting the information used to enable mixed mode joint transmission on different layers with only two TRPs.

In the aspects described herein, a wireless network may enable mixed mode or type joint transmission including non-coherent joint transmission and coherent joint transmission. The mixed modes may be on a per layer basis or across layers. Additionally, CSI reporting enhancements are also described to include support for reporting information for different configurations or combinations of coherent and non-coherent joint transmission.

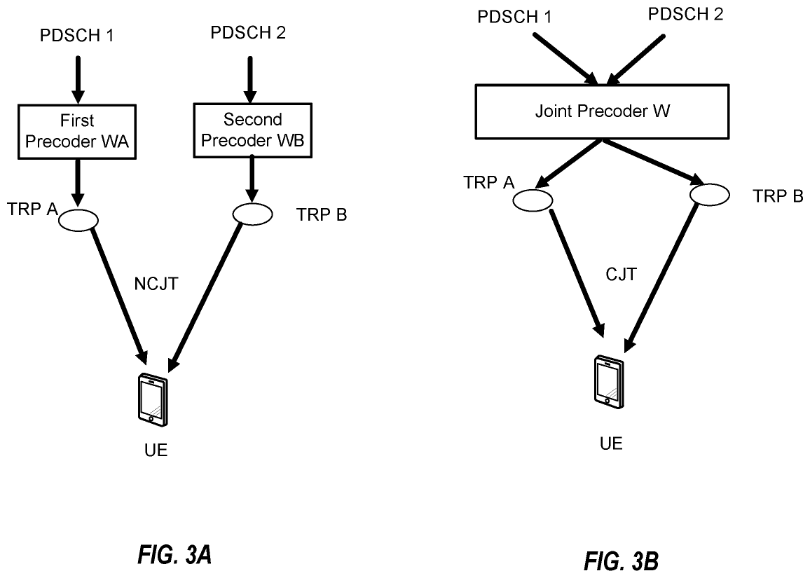

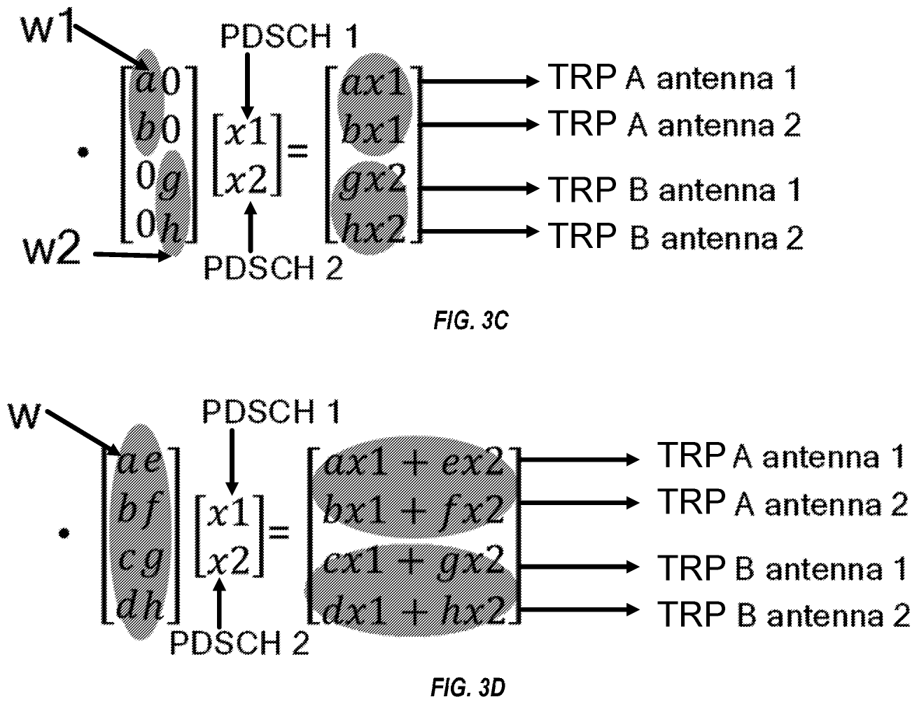

FIGS. 3A and 3B illustrate examples for non-coherent joint transmission and coherent joint transmission respectively. In FIGS. 3A and 3B precoding matrices are illustrated and denoted by the notation W.

A precoding matrix W may be a compound or composite matrix which is the product of matrix multiplication. For example, the matrix W may be the product of W1×W2. The matrix W1 may indicate or correspond to a matrix having information regarding the antenna structure and may include weights for vectors of “Beams” formed by the antenna array. The matrix W2 may include or correspond to specific beams and may include information in the form a vector that functions to select certain “beams” or columns (e.g., layers) of the matrix W1. The beams may correspond to certain patterns, reference signals, or shapes of radiation generated by the antenna array.

Referring to FIG. 3A, an illustrative example of non-coherent joint transmission is depicted. In the example of FIG. 3A, two precoders are used to transmit two PDSCHs via two TRPs independently or separately. Specifically, a first PDSCH is precoded using a first precoder (Wa) and transmitted via a first TRP (TRP A), and a second PDSCH is precoded by using a second (and different) precoder (Wb) and transmitted via the second TRP (TRP B). Each TRP transmits its own transmission, and thus the individual precoders due not overlap in that they do not include precoding information for the other TRP. As will be described further with reference to FIGS. 3C and 3D, the first precoder Wa does not include information for the second TRP (TRP B) and the second precoder Wb does not include information for the first TRP (TRP A).

Referring to FIG. 3B, an illustrative example of coherent joint transmission is depicted. In the example of FIG. 3B, a joint precoder W is used to transmit two PDSCHs via two TRPs. Specifically, a first PDSCH and a second PDSCH are each precoded by the same joint precoder (W or Wab) and transmitted via the first TRP (TRP A) and the second TRP (TRP B). Each TRP transmits portions of the signal and/or electromagnetic radiation which makes up the coherent joint transmission. Thus, it may be said that both the first TRP and the second TRP each transmit the first and second PDSCH. As compared to non-coherent joint transmission, coherent joint transmission includes multiple TRPs transmitting the same transmission. In some implementations, for non-coherent joint transmission, a phase shift between the channels of the TRPS (e.g., cells) may not be reported.

FIGS. 3C and 3D illustrate precoding examples for non-coherent joint transmission and coherent joint transmission respectively. In FIGS. 3C and 3D precoding matrices are illustrated and denoted by the term W.

Referring to FIG. 3C, an illustrative example of precoding matrices used for non-coherent joint transmission, such as in the example of FIG. 3A. In the example of FIG. 3C, two precoding matrices are used to transmit (jointly transmit over overlapping resources) two transmissions. Specifically, a first precoding matrix Wa is used to transmit a first PDSCH from TRP A with/having/using a first TCI state, and a second precoding matrix Wb is used to transmit a second PDSCH from TRP B with/having/using a second TCI state. As the first and second PDSCHs are transmitted with unique precoding information, the two transmissions are said to be transmitted non-coherently and represent a non-coherent joint transmission.

In the examples of FIGS. 3C and 3D, the first and second PDSCHs are indicated as x1 and x2. The individual PDSCHs may include or be represented scalar values or a 1×1 matrix. For comparison, a joint matrix of or representing the two PDSCHs may be formed as a 2×1 matrix.

For comparison to the joint matrix W used in the coherent joint transmission of PDSCHs in FIG. 3D, the different precoding matrices of Wa and Wb used for non-coherent joint transmission may be arranged together, diagonally, as illustrated in FIG. 3C. As illustrated in the example of FIG. 3C, the combined matrix of Wa and Wb may include zeros or null values as the component matrices of Wa and Wb may be 2×1 matrices. Thus, when the two 2×1 matrices are put together diagonally, the zeros or null values are arranged (e.g., filled in) in the top right and bottom left corners. Accordingly, when the matrices for the precoders and the PDSCH transmissions are multiplied, the resulting or product matrix is a 4×1 matrix (4×2×2×1) which includes elements having a single product. Each row in the product matrix corresponds to a TRP and associated antenna port. There are two antenna ports per TRP in the examples of FIGS. 3C and 3D.

As illustrated in FIG. 3C, the first row element has a value (a×1) that corresponds to a first antenna port of the first TRP and is associated with a first TCI state (TCI state 1), and the second row element has a value (b×1) that corresponds to a second antenna port of the first TRP and is associated with the first TCI state (TCI state 1). The third row clement has a value (g×2) that corresponds to a first antenna port of the second TRP and is associated with a second TCI state (TCI state 2), and the fourth row element has a value (h×2) that corresponds to a second antenna port of the second TRP and is associated with the second TCI state (TCI state 2).

Referring to FIG. 3D, an illustrative example of a joint precoding used for coherent joint transmission, such as in the example of FIG. 3B. In the example of FIG. 3D, a joint precoding matrix is used to transmit (jointly transmit over overlapping resources) two transmissions. Specifically, a first precoding matrix W is used to transmit a first PDSCH from TRP A and is used to transmit a second PDSCH from TRP B with/having/using a second TCI state. As the first and second PDSCHs are transmitted with the same precoding information, the two transmissions are said to be transmitted coherently and represent a coherent joint transmission.

As illustrated in FIG. 3D, the first row element has a value (a×1+e×2) that corresponds to a first antenna port of the first TRP and is associated with a first TCI state (TCI state 1), and the second row element has a value (b×1+f×2) that corresponds to a second antenna port of the first TRP and is associated with the first TCI state (TCI state 1). The third row clement has a value (c×1+g×2) that corresponds to a first antenna port of the second TRP and is associated with a second TCI state (TCI state 2), and the fourth row element has a value (d×1+h×2) that corresponds to a second antenna port of the second TRP and is associated with the second TCI state (TCI state 2).

As compared to the combined precoders of FIG. 3D, the joint precoder of FIG. 3D has additional components for the matrix elements which correspond to or represent transmission/precoding weights for the “other” TRP. Thus, the joint precoder enables precoding by both TRPs for the two transmissions. Such additional precoding information may be obtained by the network prior to precoding. Currently, there are no mechanism for the UE providing such channel measurement information to the network so that the network can precode complex mixed joint transmissions from multiple layers or more than two TRPs or precode such more accurately.

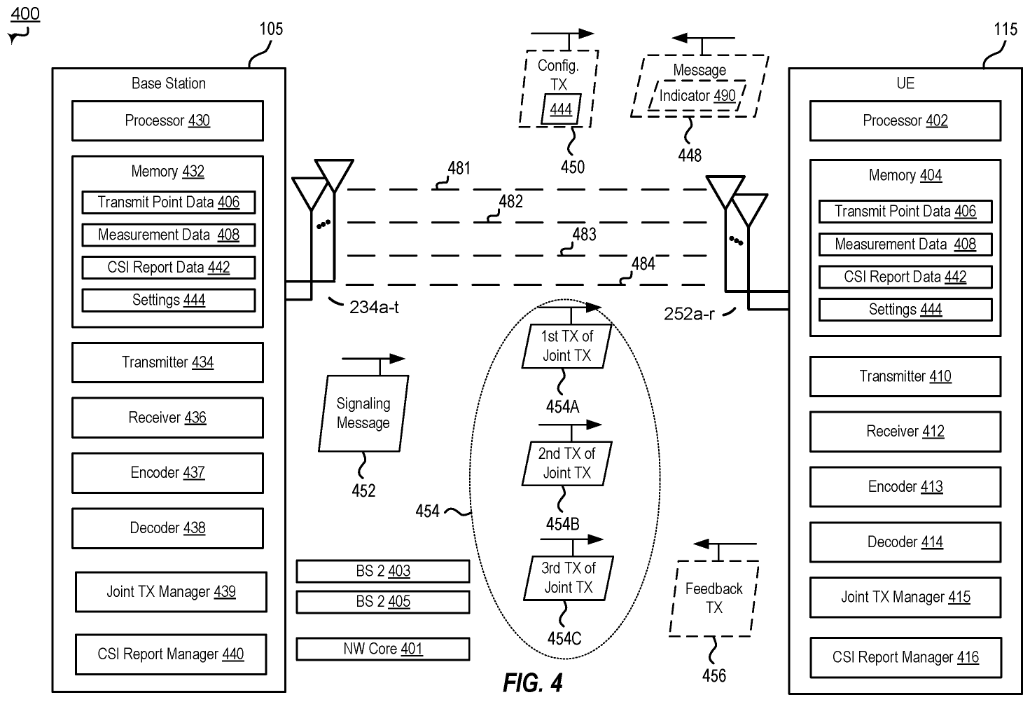

FIG. 4 illustrates an example of a wireless communications system 400 that supports enhanced joint transmission operations in accordance with aspects of the present disclosure. Enhanced joint transmission operations may include mixed mode joint transmission which include non-coherent and coherent joint transmissions, enhanced signaling and CSI reporting for mixed mode joint transmission, or both. In some examples, wireless communications system 400 may implement aspects of wireless communication system 100. For example, wireless communications system 400 may include a network, such as one or more network entities, and one or more UEs, such as UE 115. As illustrated in the example of FIG. 4, the network includes a network core 401 and multiple base stations (105, 403, 405). A network entity may include or correspond to a base station (e.g., base station 105) or a portion of a base station (e.g., radio head, antenna array, antenna port, etc.) in such implementation where aspects of a traditional base station are distributed amongst multiple devices which may be non-co-located (e.g., in different locations), such as in open RAN (O-RAN). Alternatively, the network entity may include or correspond to a different network device (e.g., not a base station). Enhanced joint transmission operations may reduce latency and increase throughput. Thus, network and device performance can be increased.

Network core 401, base stations 105, 403, 405, and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHZ” band in various documents and articles. A similar nomenclature issue sometimes occurs with regard to FR2, which is often referred to (interchangeably) as a “mmWave” band in documents and articles, despite being different from the extremely high frequency (EHF) band (30 GHZ-300 GHZ) which is identified by the International Telecommunications Union (ITU) as a “mmWave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Network core 401, base stations 105, 403, 405, and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via network core 401, base stations 105, 403, 405, and UE 115. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, joint transmission manager 415, CSI report manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store transmit point data 406, measurement data 408, CSI report data 442, settings data 444, or a combination thereof, as further described herein.

The transmit point data 406 includes or corresponds to data associated with or corresponding to transmit points for joint transmissions. For example, the transmit point data 406 may include TRP information, TCI state information, operating mode information (e.g., NCJT, CJT both), cell information, etc. The transmit point data 406 may further include joint transmission configurations, such as a data structure including potential joint transmission configurations, conditions for determining which configurations to measure and/or report, etc. For example, the transmit point data 406 includes data for performing operations for transmitting and receiving joint transmission. To illustrate, the UE 115 may utilize the transmit point data 406 to interpret signaling messages and configuration settings (e.g., CSI-RS resource configurations).

The measurement data 408 includes or corresponds to data associated with or corresponding to channel measurements and quality, such as for CSI reporting. For example, the measurement data 408 may include channel quality measurements, channel characteristics, layer information, precoding information, or a combination thereof. To illustrate, the measurement data 408 include physical layer power and/or quality measurements and/or metrics. The measurement data 408 may be use to generate the CSI report data 442.

The CSI report data 442 includes or corresponds to data indicating or corresponding to CSR report transmissions. For example, the CSI report data 442 may include data indicating information of the CSI report transmissions, e.g., the payload or traffic. As an example, the CSI report data 442 includes precoding information, rank indicator information, channel quality information, or a combination thereof.

Precoding information may include a configuration of a precoder to be used by the network. The precoding information may include or correspond to a precoding matrix or matrices and may be indicated using an indicator, such a precoding matrix identifier (PMI) or precoding coefficients. Rank information may include or correspond information regarding a number of layers of the channel or used in the CSI report. The rank information may include or correspond to a rank indicator (RI) used to indicate a number of layers supported.

Channel quality information may include channel quality information to be used by the network. The channel quality information may include or correspond to an indicator, such a channel quality indicator (CQI). The indicator may be a scalar quantity used to represent overall channel quality, such as highest modulation coding scheme (MCS) to meet desired or set operations conditions, such as BLER (block error rate).

The settings data 444 includes or corresponds to data associated with enhanced joint transmission operations. The settings data 444 may include one or more types of joint transmission operation modes and/or thresholds or conditions for switching between joint transmission modes and/or configurations. For example, the settings data 444 may have data indicating different thresholds and/or conditions for different joint transmission modes, such as a single signaling mode, a multiple signaling mode, an implicit operation mode, an explicit configuration mode (e.g., configuration setup by RRC), etc., different joint transmission configurations (e.g., combinations of NCJT and CJT).

Additionally, or alternatively, the settings data 444 may include one CSI report settings information. For example, the settings data 444 may include CSI-RS resource information, CSI-RS report configuration information, CSI-RS report timing information, CSI-RS report timing triggering mode/type, etc., or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Joint transmission manager 415 (e.g., an enhanced joint transmission manager or mixed mode (NCJT/CJT) transmission manager) may be configured to determine and perform enhanced joint transmission transmit and receive operations. For example, joint transmission manager 415 may be configured to determine joint transmission timing, joint transmission generation, joint transmission reception, etc. As another example, joint transmission manager 415 is configured to determine whether to perform enhanced joint transmission operations. In some implementations, the joint transmission manager 415 is configured to determine what particular joint transmission mode to operate in, such as single or multiple signaling. In a particular implementation, the joint transmission manager 415 is configured to determine which configuration of NCJT and/or CJT is being used.

CSI report manager 416 may be configured to determine and CSI measurement and reporting operations, such as CSI measurement and reporting operations for enhanced joint transmission operations. For example, CSI report manager 416 is configured to determine when to measure, what to measure, when to report, what to report, who to report to, etc. To illustrate, the CSI report manager 416 may be configured to determine which configurations and/or combinations of NCJT and/or CJT is being measured and/or reported. In some implementations, the CSI report manager 416 may be configured to determine or estimate additional configuration information to report based on measured configurations.

Base station 105 includes processor 430, memory 432, transmitter 434, receiver 436, encoder 437, decoder 438, joint transmission manager 439, CSI report manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store transmit point data 406, measurement data 408, CSI report data 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of UE 115 described with reference to FIG. 2.

Encoder 437, and decoder 438 may include the same functionality as described with reference to encoder 413 and decoder 414, respectively. Joint transmission manager 439 may include similar functionality as described with reference to joint transmission manager 415. CSI report manager 440 may include similar functionality as described with reference to CSI report manager 416.

Network core 401, second base station 403, and/or third base station 405 may include one or more elements similar to base station 105. Network core 401 and base station 105, 403, 405 may be configured to communicate over a wired communication network (e.g., backhaul network).

During operation of wireless communications system 400, the network (e.g., network core 401, base station 105, second base station 403, and/or third base station 405) may determine that UE 115 has enhanced joint transmission operation capability. For example, UE 115 may transmit a message 448 that includes an enhanced joint transmission indicator 490 (e.g., a mixed mode joint transmission capability indicator). Indicator 490 may indicate enhanced joint transmission operation capability for one or more communication modes, such as downlink, uplink, etc. In some implementations, a network entity (e.g., a base station 105) sends control information to indicate to UE 115 that enhanced joint transmission operation and/or a particular type of enhanced joint transmission operation is to be used. For example, in some implementations, message 448 (or another message, such as configuration transmission 450) is transmitted by the UE 115. The configuration transmission 450 may include or indicate to use enhanced joint transmission operations or to adjust or implement a setting of a particular type of enhanced joint transmission operation. For example, the configuration transmission 450 may include settings data 444, as indicated in the example of FIG. 4, CSI report data 442, or both.

During operation, devices of wireless communications system 400, perform enhanced joint transmission operations. For example, the network and UE 115 may exchange joint transmissions via uplink and/or downlink communications, such as via a downlink channel as illustrated in the example of FIG. 4. The joint transmission may include multiple PDSCHs transmitted by multiple transmit points of the network via overlapping transmission resources, and may include mixed mode or mixed types of joint transmissions, such as NCJT and CJT.

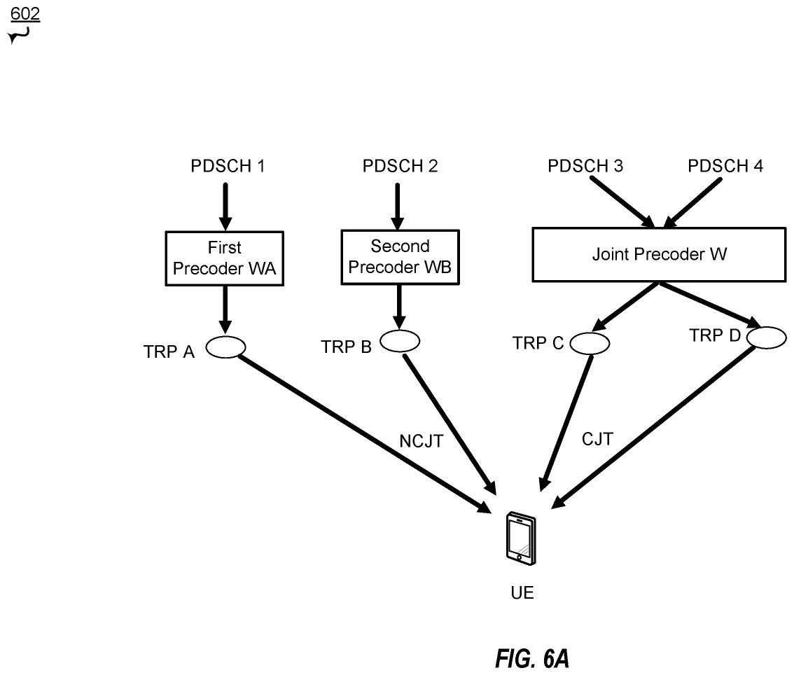

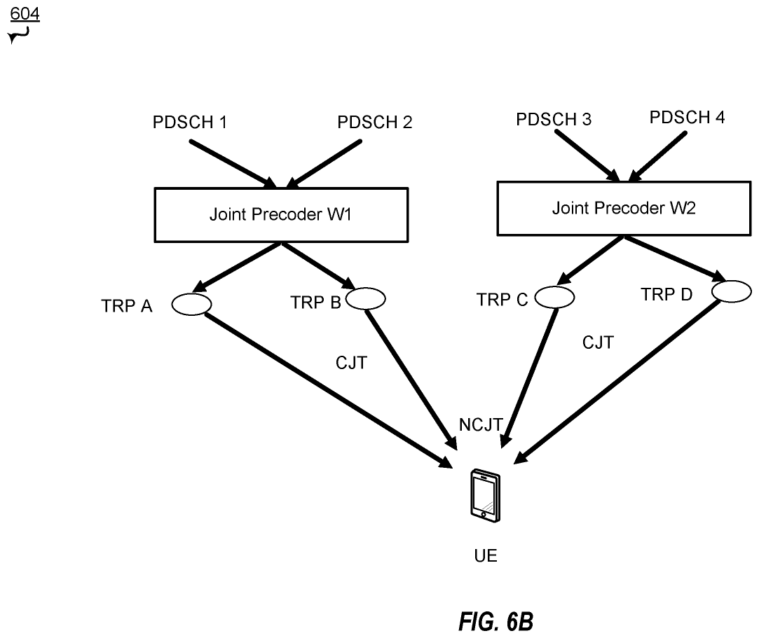

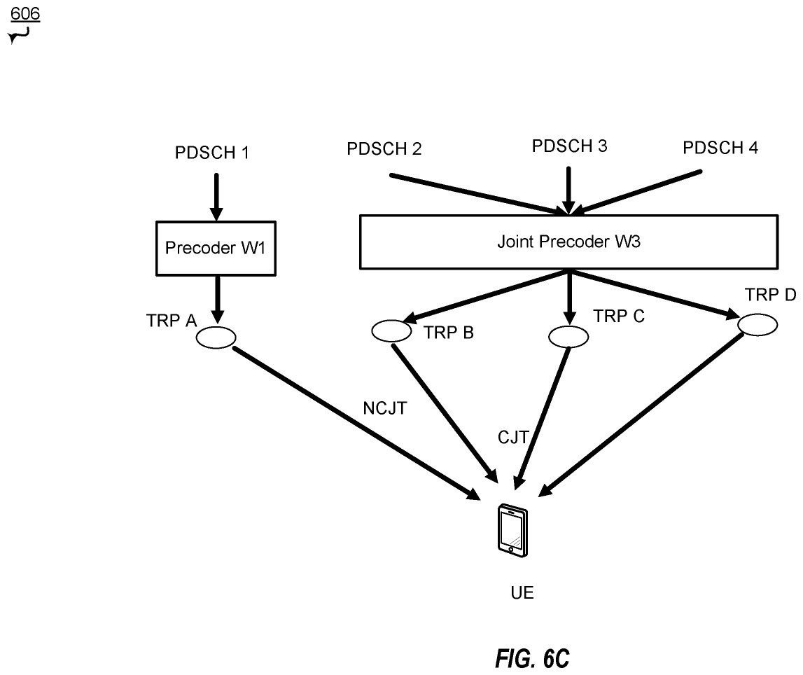

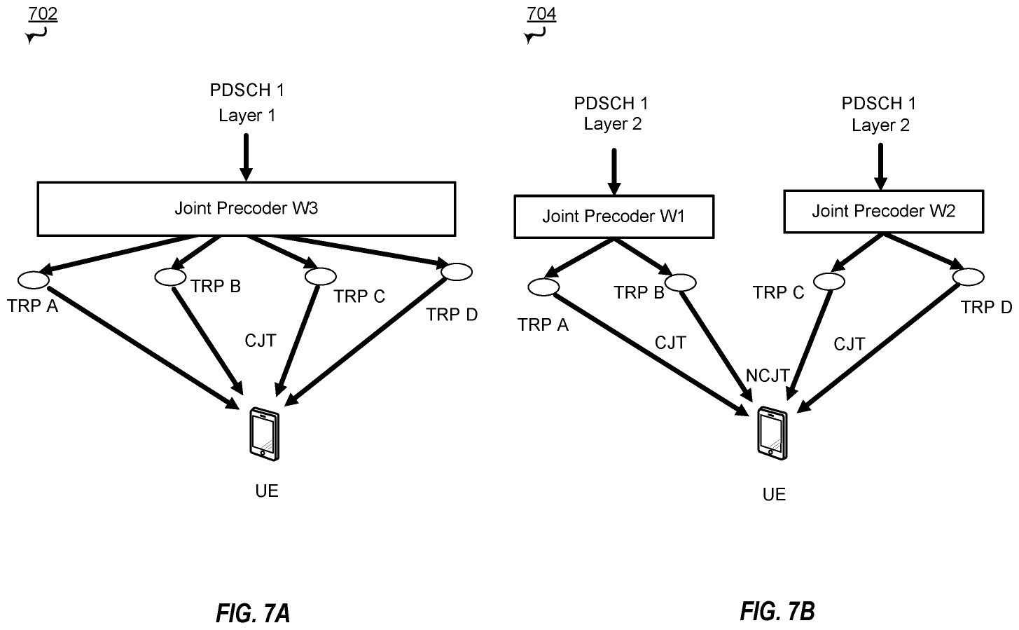

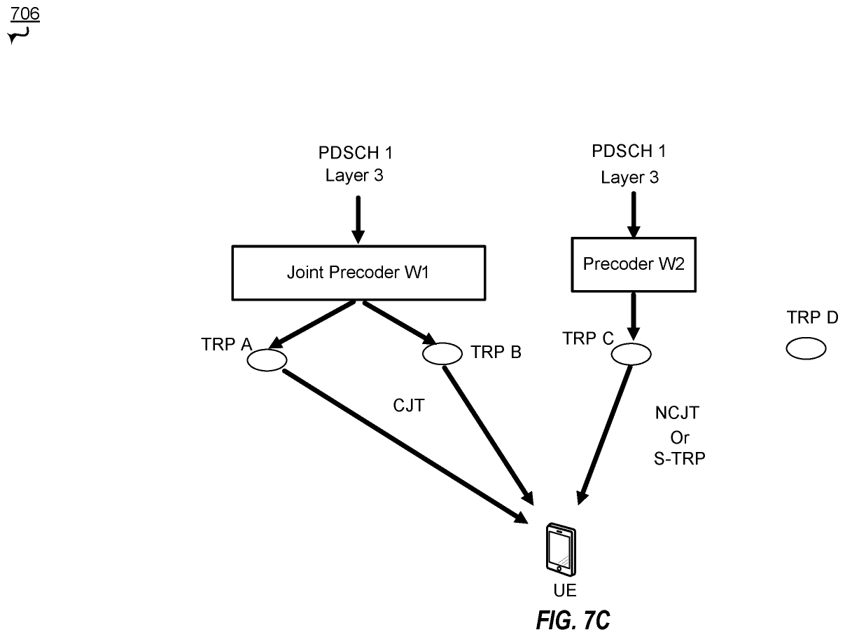

In the example of FIG. 4, the base station 105 transmits a signaling message 452 including a signaling indication for a joint transmission. The signaling message 452 may include or correspond to a joint transmission scheduling message. In some implementations, the signaling message 452 comprises a PDCCH transmission, such as a DCI. In some other implementations, the signaling message 452 comprises a MAC-CE or RRC message. The signaling indication may identify an enhanced or mixed mode joint transmission in some implementations. In a particular implementation, the signaling indication identifies a particular configuration of the mixed mode joint transmission, such as which TRPs are transmitting coherently and what TRPs are transmitting non-coherently, such as which transmissions are NCJT and which are CJT. Examples of such configurations are illustrated and described further with reference to FIGS. 6A-6C and 7A-7C.

Although one signaling message is illustrated in the example of FIG. 4, in other implementations additional signaling messages may be used to indicate and/or schedule the joint transmission. For example, the joint transmission may be signaled by multiple signaling message sent from multiple transmit points, such as in a multi DCI mode. To illustrate, one or more other base stations (or TRPs thereof), such as the second or third base station 403 and/or 405, participating in the joint transmission may transmit another signaling message to indicate the joint transmissions or their respective portions of the join transmission.

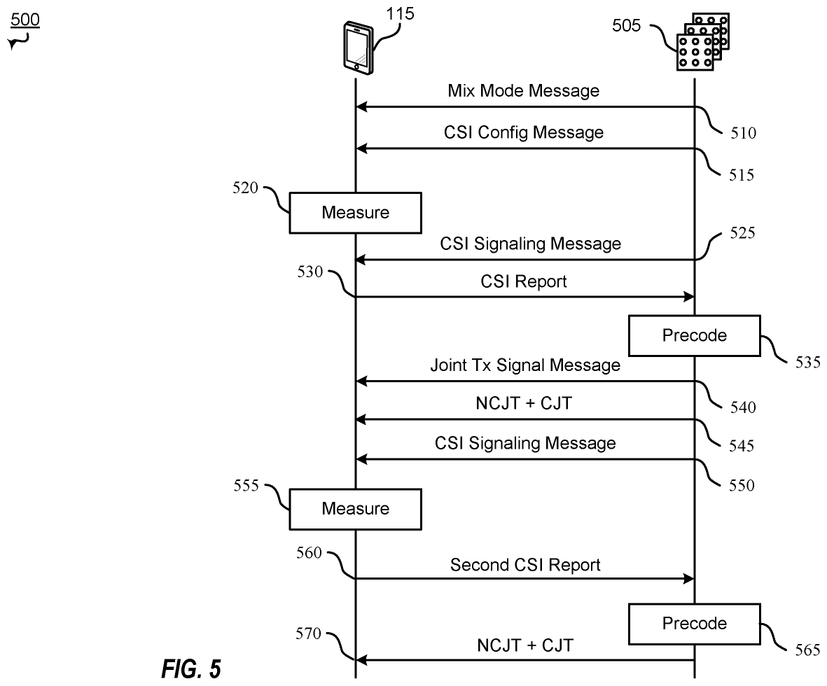

The UE 115 may receive the signaling message 452 (or signaling messages) and may perform one or more evaluations or determinations on the signaling message 452 or using the signaling message 452 (or signaling messages). The UE 115 may determine an indication of a joint transmission and a schedule of at least a first portion of the joint transmission based on the signaling indication of the signaling message 452, and may use this information to monitor for resources for at least the first portion. The UE 115 may determine scheduling information for multiple portions or the entirety of the joint transmission based on the signaling message 452 in some implementations, such as based on the signaling indication and/or scheduling information. Additionally, the UE 115 may determine receiver settings based on the signaling message 452. For example, the UE 115 may determine how to decode or separate components of the joint transmission based on the signaling indication. Examples of indication and scheduling operation variations for signaling messages are further described with reference to FIG. 5.

The network transmits a joint transmission 454, including multiple transmissions transmitted concurrently, based on the signaling message 452. In the example of FIG. 4. the base stations 105, 403, and 405 transmit three transmissions jointly, a first transmission 454A, a second transmission 454B, and a third transmission 454C, on overlapping transmission resources. The first, second, and third transmissions 454A-454C may include or comprise data channel transmissions, such as PDSCHs. Each transmission of the first, second, and third transmissions 454A-454C may include or correspond to its own PDSCH.

The first, second, and third transmissions 454A-454C may be transmitted in a mixed mode joint transmission. For example, the first, second, and third transmissions 454A-454C include a mixture of NCJT and CJT. To illustrate, two or more of the transmissions are transmitted coherently, such as by the base station 105 and the second base station 403, and the coherent transmissions are transmitted non-coherently with the other remaining transmission (from the third base station 405) in the example of FIG. 4.

As an illustration, the first and second transmissions 454A and 454B may be transmitted as a coherent joint transmission by two transmit points with a same precoder where each transmit point transmits both the first and second transmissions 454A and 454B. Specifically, the two transmit points (two TRPs) transmit a portion of the electromagnetic radiation which forms the beams to transmit the signals. The first and second transmissions 454A and 454B may be transmitted non-coherently with the third transmissions 454C. Specifically, the third transmission 454C is transmitted by a third transmit point (e.g., TRP) alone and using a second precoder different from the joint precoder used for the first and second transmissions 454A and 454B. The precoding information (or an indication thereof) may be sent to the network by the UE 115 prior to the joint transmission 454, such as in a CSI report, as further described with reference to FIG. 5.

The UE 115 monitors transmission resources associated with the joint transmission based on the signaling message 452. The UE 115 may optionally receive and successfully decode one or more of the transmissions (PDSCHs) of the joint transmission while monitoring the transmission resources. For example, the UE 115 may perform receive or receive chain operations, demodulating, routing, filtering, decoding, combining, etc., based on a configuration of the joint transmission indicated in the signaling message 452 and/or previously indicated by the UE 115 in a CSI report, as described further with reference to FIG. 5.

The UE 115 may optionally transmit a feedback transmission 456 responsive to the joint transmission 454. For example, the UE 115 may generate feedback information message (e.g., ACK or NACK) based on monitoring for and/or processing the joint transmission 454 and may provide the feedback information indicating successful reception and processing of one or more transmissions (454A-454C) of the joint transmission 454 in a feedback acknowledgment message, such as via a HARQ-ACK process. The feedback transmission 456 may be sent to a single transmit point of the network (e.g., base station 105), to multiple transmit points of the network, or all transmit points of the network which transmitted the joint transmissions 454. In some implementations, the feedback transmission 456 comprises a PUCCH transmission, such as a UCI. In some other implementations, the feedback transmission 456 comprises a MAC-CE.

Accordingly, the network (e.g., the TRPs of a base station or base stations and the UE 115) may be able to more efficiently perform enhanced joint transmission operations including mixed mode/type joint transmissions and/or provide indications of joint transmission configurations in CSI reports. Thus, FIG. 4 describes enhanced joint transmission operations. Using enhanced joint transmission operations enables increased throughput and reduced latency by enabling the usage of additional TRPs (e.g., more than two TRPs) to transmit data in additional flexible or more efficient ways.

Referring to FIG. 5, FIG. 5 illustrates an example diagram 500 of a wireless communication system that supports enhanced joint transmission operations, including CSI reporting operations for supporting some mixed mode joint transmission operations, according to one or more aspects. The example of FIG. 5 includes similar devices to the devices described in FIGS. 1, 2, and 4, such as UE 115 and a network entity 505. The devices, such as UE 115 and network entity 505, of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate joint transmissions and receive the joint transmissions. Network entity 505 may include or correspond to multiple TRPs of a single base station (e.g., base station 105), to multiple base stations (e.g., base stations 105, 403, 405), or any combination thereof.

Although the example illustrated in FIG. 5 depicts a single network entity (with multiple transmit points) and a single UE, in other implementations, the operations may occur between other wireless communication devices, such as two UEs, vehicle UEs, base stations, IoT devices, etc., and the network may include multiples of such devices. For example, the network entity 505 may include one or more nodes. To illustrate, the network entity 505 may include multiple base stations and/or the base station or stations may include multiple devices, such as transmit points. Such transmit points may include or correspond to different base stations, or to different antenna elements, panels and/or TRPs of a single base station. In some implementations, each transmit point may have its own or be associated with its own TCI state.

At 510, the network entity 505 transmits a joint transmission mixed mode message, such as a joint transmission configuration message. The joint transmission configuration message may include or correspond to the configuration transmission 450 or the signaling message 452 of FIG. 1. For example, the network entity 505 transmits a DCI to the UE 115 which indicates to operate in a mixed mode type joint transmission operating mode. As other examples, the network device (e.g., base station 105) transmits a MAC-CE or RRC message to the UE 115 which indicates to operate in a mixed mode type joint transmission operating mode and/or which indicates a joint transmission. The joint transmission mixed mode message may include or provide a joint transmission indication. In some implementations, the message schedules a particular joint transmission.

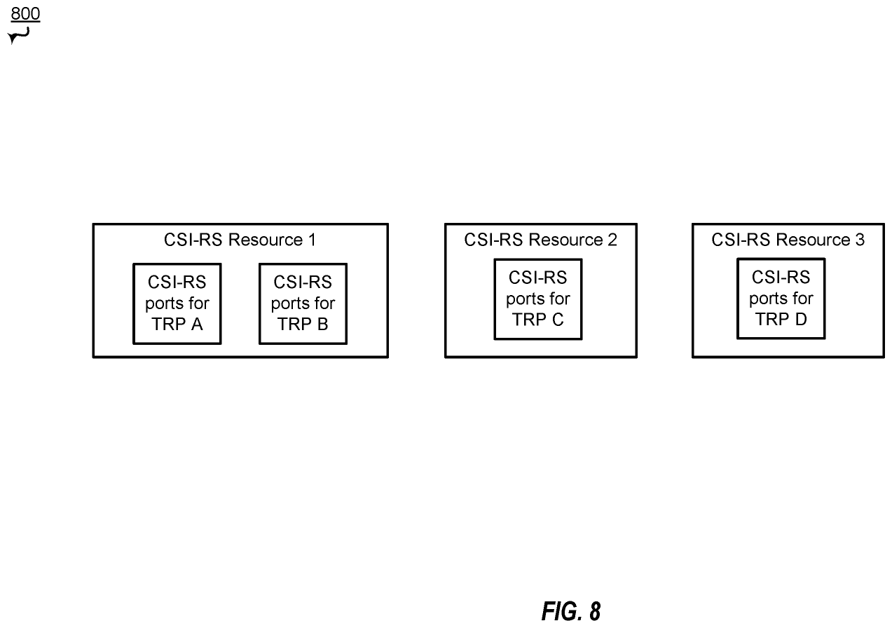

Additionally, the joint transmission mixed mode message may include or indicate CSI configuration information. For example, when a separate CSI configuration message is not used, the joint transmission mixed mode message may include or indicate the CSI configuration information. The CSI configuration information may include or correspond to the CSI report data 442 of FIG. 4, the settings data 444 of FIG. 4, or a combination thereof. As described with reference to FIG. 4, the CSI configuration information may include configurations for CSI measurements, CSI reporting, or both, and may include resource information for CSI measurements and reports. In some implementations, the CSI configuration information may be used to provide indications for configurations of joint transmissions, such as which configurations of NCJT and CJT to measure and report. Examples of using CSI information for indication of configurations of NCJT and CJT are further provided and described with reference to FIG. 8.

The UE 115 receives and decodes the joint transmission mixed mode message and processes the message to determine joint transmission configuration information for one or more future joint transmission, for CSI reporting to enable the future joint transmissions, or both.

In some implementations, the UE 115 may optionally transmit a joint transmission mixed mode indication that it is capable of concurrent NCJT and CJT, such as a joint transmission mixed mode capabilities message. In some such implementations, the UE 115 transmits the joint transmission mixed mode indication prior to receiving the joint transmission mixed mode message at 510. In other such implementations, the UE 115 transmits the joint transmission mixed mode indication after receiving the joint transmission mixed mode message at 510, such as to acknowledge the joint transmission mixed mode message. Alternatively, the UE 115 may transmit the joint transmission mixed mode indication independent of a joint transmission mixed mode message.

At 515, the network entity 505 transmits a CSI configuration message, such as a CSI report resource configuration message, including CSI configuration information. For example, the network entity 505 transmits a RRC configuration message or MAC CE to the UE 115 which indicates one or more CSI resources for reporting CSI measurement in a CSI report. Additionally, or alternatively, the message (e.g., the RRC configuration message) includes or indicates one or more settings of the CSI report or reporting procedure. For example, the message may identify a type or format of the CSI report and a particular reporting or signaling procedure such as aperiodic/dynamic, semi-periodic/persistent, or periodic/persistent.

The UE 115 receives and decodes the CSI configuration message. For example, the UE 115 receives the CSI configuration message and parses the CSI configuration message to obtain the CSI configuration information.

At 520, the UE 115 performs one or more CSI measurement operations. For example, the UE 115 performs one or more channel measurement operations on the channel and/or reference signal transmissions from the network entity 505 to determine measurement information (or referred to generally as measurements) based on the CSI configuration information. The measurement information may be used to generate precoding information and/or channel quality information for a CSI report.

In some implementations, the UE 115 further determines which measurements to perform, such as which configuration or combination of NCJT and CJT to measure and/or report, based on the CSI configuration information. In such implementations, the UE 115 may determine to measure select combinations of NCJT and/or CJT for potential reporting. As described above, the UE 115 may determine this information (which combinations or subset of combination to report) based on UE settings and/or network indication. In a particular implementation, the UE 115 reports all combinations. In some other implementations, the UE determines which subset of combination to report based on a determination at the UE 115, such as based on UE selection criteria, and independent of network indication. The UE selection criteria may include one or more thresholds or conditions for prioritizing and/or selecting combinations. As illustrative examples, power conditions, quality conditions, blockage conditions, etc., can be used for selection of combinations. In other implementation, the UE 115 determines which subset of combination to report based on an indication from the network indication, which may be implicit or explicit. Detailed examples of implicit and explicit options are described further with reference to FIG. 8.

At 525, the network entity 505 optionally transmits a CSI signaling message. For example, the network entity 505 transmits a CSI signaling message (e.g., activation or trigger message) to signal to the UE 115 to report CSI. This CSI signaling message may signal or identify the resources and configuration of the CSI explicitly or implicitly. For example, the CSI signaling message itself may include CSI report information and be independent of the CSI configuration message. Alternatively, the CSI signal message may indicate settings or resources from prior identified information by the CSI configuration message.

At 530, the UE 115 transmits a CSI report. For example, the UE 115 transmits a CSI report responsive to the CSI signaling message at 525, the CSI configuration message at 515, or both, indicating transmission information for an upcoming (e.g., second) joint transmission, which may be a mixed mode transmission. The CSI report may include or indicate one or more measurements (or information derived therefrom) from the measurement operations at 520.

As described further with reference to FIGS. 3A-3D and 4, the CSI report may include precoding information (e.g., PMI), rank information (e.g., RI), channel quality information (e.g., CQI), etc., or a combination thereof. The information of the CSI report may include information to different possible combinations of mixtures of NCJT and CJT transmission. For example, the CSI report may include measurements and/or indications for different combinations or configurations of NCJT and CJT.

At 530, the network entity 505 precodes a joint transmission. For example, the network entity 505 uses multiple different precoders to transmit the transmissions (components or portions) of a compound or composite transmission. For a particular joint transmission the network entity 505 uses two or more precoders, such as for multilayer or MIMO level mixed joint transmission or uses three or more precoders, such as for single layer or TRP level mixed joint transmissions. The non-coherent joint transmission may be precoded as described with reference to FIG. 3C and the coherent joint transmission may be precoded as described with reference to FIG. 3D. As an illustrative example, the network entity generates one or more precoders based on the precoding information included in the CSI report. Additional example configurations of NCJT and CJT and precoding details are illustrated and described further with reference to FIGS. 6A-8.

At 535, the network entity 505 transmits a joint transmission signaling message. For example, the network entity 505 transmits a signaling message including a signaling indication for the joint transmission to the UE 115 to identify or signaling a forthcoming joint transmission. The joint transmission signaling message may include or correspond to a DCI or MAC CE transmission and may include a grant for transmission resources to be used for the joint transmission. In some implementations, the joint transmission signaling message, such as the signaling indication thereof, include joint transmission type configuration information. For example, the joint transmission signaling message indicates which transmissions are coherent and which transmissions are non-coherent, and which transmissions are transmitted by which transmit points. This may further include TRP and/or TCI state information.

Although one signaling message is indicated in the example of FIG. 5, in other implementations multiple signaling messages may be used. For example, multiple signaling messages may be sent in a joint scheduling or indication mode, such as dual DCI, tri DCI, etc. To illustrate, each TRP may send its own respective signaling message scheduling a portion of the joint transmission. Alternatively, each TRP may send redundant signaling messages which schedule the entire joint transmission. When one signaling message is used, the signaling message may still correspond to one base station, and the TRPs may correspond different panels of the same base station for a particular implementation.

At 545, the network entity 505 transmits a joint transmission, such as an enhanced or mixed mode joint transmission which includes NCJT and CJT components or transmissions. For example, the network entity 505 transmits a set of PDSCH transmissions (e.g., 4 PDSCHs) concurrently or via overlapping transmission resources to the UE 115 based on the indication of the signaling message. The signaling message may indicate and/or schedule the set of PDSCH transmissions in the example of FIG. 5. Each transmission of the set of transmission may correspond to, i.e., be transmitted by, a different transmit point of the network entity 505. Additionally, each transmit point of the network entity 505 may have a different TCI state. Thus, as an illustrative example, the network entity 505 may transmit 4 PDSCHs from four different transmit points where each transmit point and/or PDSCH has or is associated with a different TCI state.

Additional example configurations of NCJT and CJT are illustrated and described further with reference to FIGS. 6A-8. The configurations of NCJT and CJT may be on a same or different layer of the channel. For example, the mixed types may be on the same layer, such a TRP mixed mode, as described with reference to FIGS. 6A-6C, or the mixed types may be on different layers, such as described with reference to FIGS. 7A-7C.

The UE 115 may receive and decode the joint transmission. For example, the UE 115 may monitor resources associated with the component PDSCH transmissions of the joint transmission based on the joint transmission signaling message which scheduled at least a portion of the joint transmission. The UE 115 may successful receive and decode each PDSCH transmission of the joint transmission.

From 550 to 570, the network may optionally perform a second joint transmission similar to the joint transmission. Although the example in FIG. 5 illustrates two joint transmissions (and specifically two mixed mode joint transmissions which include coherent and non-coherent transmissions), in other implementations, only one joint transmission may be transmitted and/or one of the joint transmissions may be a standard or single mode joint transmission.

At 550, the network entity 505 optionally transmits a second CSI signaling message. For example, the network entity 505 transmits a second CSI signaling message (e.g., activation or trigger message) to signal to the UE 115 to report second CSI. Similar to the CSI signaling message at 525, the second CSI signaling message may signal or identify the resources and configuration of the second CSI explicitly or implicitly. For example, the second CSI signaling message itself may include second CSI report information and be independent of the CSI configuration message. Alternatively, the second CSI signaling message may indicate settings or resources from prior identified information by the CSI configuration message.

At 555, the UE 115 performs one or more second CSI measurement operations. For example, the UE 115 performs one or more second channel measurement operations on the channel and/or reference signal transmissions from the network entity 505 to determine second measurement information (or referred to generally as measurements) based on the CSI configuration information. The measurement information may be used to generate second channel quality information and/or a second CSI report.

Additionally, the UE 115 may further determine which measurements to perform, such as which configuration or combination of NCJT and CJT to measure and/or report, based on the CSI configuration information and/or the second CSI signaling message, similar to described with reference to 525 and further with reference to FIG. 8.

At 560, the UE 115 transmits a second CSI report. For example, the UE 115 transmits a second CSI report responsive to the second CSI signaling message at 550, the CSI configuration message at 515, or both, indicating second transmission information for an upcoming (e.g., second) joint transmission, which may be a mixed mode transmission. The second CSI report may include or indicate one or more second measurements (or information derived therefrom) from the measurement operations at 555.

As described above and further with reference to FIGS. 6A-8, the second CSI report may include precoding information (e.g., PMI), rank information (e.g., RI), channel quality information (e.g., CQI), etc., or a combination thereof. The information of the second CSI report may include information to different possible combinations of mixtures of NCJT and CJT transmission. For example, the second CSI report may include measurements and/or indications for different combinations or configurations of NCJT and CJT. The second combinations or configurations of NCJT and CJT indicated by the second CSI report may be the same as or different from the first combinations or configurations of NCJT and CJT indicated by the first CSI report.

A configuration of the second CSI report may be the same as or different from the CSI report (e.g., first CSI report) at 525. Additionally, or alternatively, an intended target and/or recipient of the second CSI report may be the same as or different from an intended target and/or recipient the CSI report (e.g., first CSI report) at 525. For example, the UE 115 may transmit individual CSI reports to each TRP or a joint CSI report to one or more TRPs. The individual CSI reports may include information respective to only the intended TRP, while the joint CSI report may include information for multiple TRPs.

At 565, the network entity 505 precodes a second joint transmission. For example, the network entity 505 uses multiple different precoders to transmit the second transmissions (components or portions) of a second compound or composite transmission. As described with refence to 535, the network entity 505 generates one or more precoders based on the second precoding information included in the second CSI report.

Optionally, the network entity 505 transmits a second joint transmission signaling message. For example, the network entity 505 transmits a second signaling message including a second signaling indication for the second joint transmission to the UE 115 to identify or signaling a forthcoming second joint transmission. The second joint transmission signaling message may be similar to the joint transmission signaling message at 540.

At 570, the network entity 505 transmits a second joint transmission, such as an enhanced or mixed mode joint transmission which includes second NCJT and CJT components or transmissions. For example, the network entity 505 transmits a second set of PDSCH transmissions (e.g., 4 PDSCHs) concurrently or via overlapping transmission resources to the UE 115 based on the indication of the second signaling message. The second signaling message may indicate and/or schedule the second set of PDSCH transmissions in the example of FIG. 5. Each transmission of the second set of transmission may correspond to, i.e., be transmitted by, a different transmit point of the network entity 505. Additionally, each transmit point of the network entity 505 may have a different TCI state. Thus, as an illustrative example, the network entity 505 may transmit 4 second PDSCHs from four different transmit points where each transmit point and/or second PDSCH has or is associated with a different TCI state. A configuration of the second joint transmission may be the same as or different from the joint transmission (e.g., first joint transmission) at 545.

Optionally, the UE 115 transmits an acknowledgment message responsive to one or more of the joint transmissions. For example, the UE 115 may generate acknowledgment information for each joint transmission and transmit the acknowledgment information in a same report or transmission. As another example, the UE 115 may generate first acknowledgment information for the joint transmission and report the first acknowledgment information separate from second acknowledgment information for the second joint transmission. In either scheme, the UE 115 may transmit the acknowledgment message to a single transmit point of the network or to multiple transmit points of the network. For example, the UE 115 may transmit one combined feedback message to a first transmit point including feedback for each transmission of the joint transmission. Alternatively, the UE 115 may transmit multiple feedback messages to each transmit point which transmitted the joint transmission. In some implementations, the feedback messages are the same, such as redundant, and indicate the same acknowledgement information for all transmissions of the joint transmission. In other implementations, the feedback messages are different, such as each message only includes acknowledgement information for a respective transmission or transmissions for the respective transmit point.

Thus, in the example in FIG. 5, the wireless communication devices perform enhanced joint transmission operations including mixed mode joint transmissions. The mixed mode joint transmissions may be supported by CSI reporting operations to measure and feedback channel information (including precoding) information used to enable mixed mode joint transmission. The enhanced joint transmission operations may enable increased throughput and reduced latency by enabling a more flexible use of more transmit points and/or MIMO layers.

FIGS. 6A-6C and 7A-7C illustrate examples of diagrams of example configurations of mixed NCJT and CJT transmission according to one or more aspects. The examples of FIGS. 6A-6C and 7A-7C include similar devices to the devices described in FIGS. 1, 2, and 4, such as UE 115 and one or more base stations (e.g., 105, 403, or 405). The devices, such as UE 115 and base station 105, 403, or 405, of FIGS. 6A-6C and 7A-7C may include one or more of the components as described in FIGS. 2 and 4. In FIGS. 6A-6C and 7A-7C, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate transmissions and receptions.

Referring to FIGS. 6A-6C, FIGS. 6A-6C are diagrams 602-606 of example configurations of mixed NCJT and CJT transmission (e.g., various mixed mode joint transmissions examples). The example configurations of FIGS. 6A-6C illustrate single layer channel examples. In some implementations, a channel for a transmission may have multiple layers and each layer may have the same configuration, or one or more of the multiple layers may have a different configuration as described with reference to FIGS. 7A-7C.

Joint transmission configuration, also referred to herein as simply configuration or combination, corresponds to a particular transmission configuration of the transmissions which make up the joint transmission and how they are transmitted, such as which transmit points are transmitting which transmission and which transmissions are transmitted coherently and which are transmitted non-coherently. The joint transmission configuration may further identify how many precoders are used and which transmit points share a precoder (use a joint precoder) and which transmit points use a separate, dedicated precoder.

In the examples of FIGS. 6A-6C, four transmit points are illustrated transmitting data to a single UE. The four transmit points (e.g., TRPs) may transmit transmissions (e.g., data or PDSCH) at the same time. For example, the four transmit points may transmit data on overlapping transmission resources. The overlapping transmission resources may include frequency resources (FDD), time domain resource (TDD), spatial domain resources (SDD), or a combination thereof.

In the examples of FIGS. 6A-6C, the four transmit points are each transmitting a data channel transmission, such as a PDSCH. For example, a first transmit point transmits a first PDSCH, a second transmit point transmits a second PDSCH, a third transmit point transmits a third PDSCH, and a fourth transmit point transmits a fourth PDSCH.

Referring to FIG. 6A, FIG. 6A is a diagram 602 of an example configuration of mixed NCJT and CJT transmission (mixed mode joint transmission). In the first example of FIG. 6A, the four transmissions are joint transmitted. Specifically, a first transmission is transmitted by a first transmit point, a second transmission is transmitted by a second transmit point, and third and fourth transmissions are transmitted by third and fourth transmit points. Each of the third and fourth transmit points may transmit portions of the third and fourth transmissions. The first transmission has a first TCI state, the second transmission has a second TCI state, the third transmission has a third TCI state, and the fourth transmission has a fourth TCI state. Each TCI state is different from the other TCI state in some implementations. Alternatively, in other implementations, one or more of TCI states of the four TCI states of the four transmissions are the same.

As illustrated, the third and fourth transmissions are coherent joint transmitted (e.g., were precoded) by the transmit points using the same precoding information (e.g., joint precoder W3). The first and second transmissions are non-coherent joint transmitted with the third transmission and with the fourth transmission where each of the transmission sets (e.g., a first set of the first PDSCH, a second set of the second PDSCH, and a third set of the third and fourth PDSCHs) have a different precoder from each other.

To illustrate, the first transmission is precoded with a first precoder and the second transmission is precoded with a second precoder, both of which are different from each other and from a third or joint precoder used to precode the third and fourth transmissions.

In some implementations, a joint precoder (e.g., the first precoder) used to precode two or more transmission may include precoding information for both transmit points, such as described with reference to FIGS. 3A-3D. For example, a precoding matrix of joint precoder W3 is comprised of (is the product of matrix multiplication of) component matrices W3₁ and W3₂, where each of W3₁ and W3₂ have information for both transmit points. On the other hand, a (non-joint) precoder may include information for only one transmit point. For example, the single or non-joint precoder W is comprised of (is the product of matrix multiplication of) component matrices W₁ and W₂, where each of W₁ and W₂ only have information for their respective transmit points and do not have information for both transmit points.

Referring to FIG. 6B, FIG. 6B is a diagram 604 of an example configuration of mixed NCJT and CJT transmission (mixed mode joint transmission). In the second example of FIG. 6B, each of the first, second, third, and fourth transmissions are coherent joint transmitted with at least one other transmission. However, there are two different coherent joint transmissions which are transmitted non-coherently with respect to one another. Thus, two joint precoders are used, one for each set of transmissions.

In the example of FIG. 6B, a first transmission and a second transmission are coherent joint transmitted from first and second TRPs, and a third transmission and a fourth transmission are coherent joint transmitted from third and fourth TRPs. Each of these sets of coherent joint transmissions are non-coherently transmitted. That is, the first and second transmissions are non-coherent joint transmitted with the third and fourth transmissions.

To illustrate, a first PDSCH and a second PDSCH are coherent joint transmitted from a first TRP and a second TRP, a third PDSCH and a fourth PDSCH are coherent joint transmitted from a third TRP and a fourth TRP, where the first and second PDSCHs are non-coherent joint transmitted with the third and fourth PDSCHs. The first and second PDSCHs are both transmitted by the first and second TRPs together, and the first and second PDSCHs are both precoded using the same joint precoder W1. Similarly, the third and fourth PDSCHs are both transmitted by the third and fourth TRPs together, and the third and fourth PDSCHs are both precoded using the same joint precoder W2.

Referring to FIG. 6C, FIG. 6C is a diagram 606 of an example configuration of mixed NCJT and CJT transmission (mixed mode joint transmission). In the third example of FIG. 6C, a first transmission is transmitted non-coherently with the other transmissions. Each of the other transmissions, the second, third and fourth, are coherent joint transmitted.

To illustrate, a first PDSCH is transmitted from a first TRP, and a second PDSCH, a third PDSCH, and a fourth PDSCH are coherent joint transmitted from second, third and fourth TRPs, where the first PDSCH is non-coherent joint transmitted with the second, third, and fourth PDSCHs. The first PDSCH is transmitted by the first TRP alone, and the first PDSCH is precoded using a precoder W1. The second, the third, and the fourth PDSCHs are transmitted by the second, third, and fourth TRPs together, and the second, third, and fourth PDSCHs are each precoded using the same joint precoder W3.

Referring to FIGS. 7A-7C, FIGS. 7A-7C include diagrams 702-706 depicting an example configuration of mixed NCJT and CJT transmission (mixed mode joint transmission) on different layers of a same joint transmission. Each figure of FIGS. 7A-7C depicts a mixed mode joint transmission configuration of an individual layer of the joint transmission (e.g., the joint transmission 454 of FIG. 4). As described above, the joint transmission may have multiple layers and each layer may have a same or different configuration. In the example depicted in FIGS. 7A-7C, diagram 702 of FIG. 7A depicts a first joint transmission configuration for a first layer, diagram 704 of FIG. 7B depicts a second joint transmission configuration for a second layer, and diagram 706 of FIG. 7C depicts a third joint transmission configuration for a third layer. In some implementations, the joint transmission includes or corresponds to a single PDSCH, as illustrated in the example joint transmission of FIGS. 7A-7C. To illustrate, as opposed to the four PDSCHs in the examples of FIGS. 6A-6C, there is one PDSCH in the example of FIGS. 7A-7C and each layer may have multiple transmissions which are part of the single PDSCH. In other implementations, each layer or portion thereof may correspond to transmissions of different PDSCHs.

Using different joint transmission configurations of NCJT and CJT at different layers may be referred to a MIMO layer level mixing of NCJT and CJT transmission (or MIMO level mixed mode joint transmission). In a simplified example, the transmission has two layers where a first layer has a first configuration (e.g., NCJT) and a second layer has a second configuration. In this case, the mixed mode may only utilize two transmit points (e.g., TRPs) per layer. For example, a first and second TRPs operate in a NCJT mode for a first layer and transmit two first transmissions using different precoders, and the first and second TRPs operate in a CJT mode for a second layer and transmit two second transmissions using a same precoder. Alternatively, in other implementations, more than two transmit points (e.g., TRPs) may be used for this simple case and other cases. For example, as compared to the above example, the second layer could alternatively not transmit from the first and second TRP, but transmit from a third and fourth TRP. As another example, the second layer could alternatively not transmit from the first TRP, but transmit from the second TRP and a third TRP.

Referring to FIG. 7A, FIG. 7A is a diagram 702 of an example configuration of mixed NCJT and CJT transmission (mixed mode joint transmission) for a first layer of a channel. The channel may correspond to or be of the joint transmission. In a particular implementation, the channel may correspond to or be of the overlapping transmission resources of the joint transmission.

As illustrated in FIG. 7A, each of first, second, third, and fourth transmissions of a first PDSCH (e.g., first layer or first layer portion of the first PDSCH) are coherent joint transmitted (e.g., were precoded by the transmit points using the same precoding information (e.g., joint precoder W3)) with each other for a first layer of the channel. On the first layer no transmissions are transmitted non-coherently.

To illustrate, each of the first, second, third, and fourth transmissions are precoded with a same joint precoder W3, which as described above, includes precoding information for each of the four transmit points. Each of the four transmit points jointly transmit portions of the four PDSCHs (e.g., electromagnetic radiation which forms the beam).

Referring to FIG. 7B, FIG. 7B is a diagram 704 of an example configuration of mixed NCJT and CJT transmission (mixed mode joint transmission) for a second layer of the channel. As illustrated in FIG. 7B, each of the first, second, third, and fourth transmissions are coherent joint transmitted for a second layer of the channel similar to the configuration for the first layer. However, in the second layer there are two different coherent joint transmissions which are transmitted non-coherently with respective to one another, similar to as described with reference to FIG. 6B. Thus, two joint precoders (W1 and W2) are used, one for each set of transmissions.

To illustrate, a first transmission and a second transmission of a first PDSCH (e.g., second layer or second layer portion of the first PDSCH) are coherent joint transmitted from first and second TRPs, and a third transmission and a fourth transmission of the first PDSCH are coherent joint transmitted from third and fourth TRPs, where the first and second transmissions are non-coherent joint transmitted with the third and fourth transmissions. The first and second transmissions are both transmitted by the first and second TRPs together, and the first and second transmissions are both precoded using the same joint precoder W1. Similarly, the third and fourth transmissions are both transmitted by the third and fourth TRPs together, and the third and fourth transmissions are both precoded using the same joint precoder W2. Each of the transmissions has or is associated with a TCI state. The four TCI states may be the same as each other in some implementations. In other implementations, one or more TCI states of the four TCI states may be different from at least one other TCI state.

Referring to FIG. 7C, FIG. 7C is a diagram 706 of an example configuration of mixed NCJT and CJT transmission (mixed mode joint transmission) for a third layer of the channel. As illustrated in FIG. 7C, the first and second transmissions are coherent joint transmitted (e.g., were precoded by the first and second transmit points using the same precoding information (e.g., joint precoder W1)) with each other, and the first and second transmissions are transmitted non-coherently (non-coherent joint transmitted) with a third transmission from a third transmit point for the third layer of the channel. On the third layer, the fourth transmit point (TRP D) does not transmit a transmission, i.e., there is not fourth transmission for the third layer.

To illustrate, a first transmission and a second transmission of the first PDSCH (e.g., third layer or third layer portion of the first PDSCH) are coherent joint transmitted from first and second TRPs, and a third transmission of the first PDSCH from a third TRP is non-coherent joint transmitted. The first and second transmissions are non-coherent joint transmitted with the third transmission. The first and second transmissions are both transmitted by the first and second TRPs together, and the first and second transmissions are both precoded using the same joint precoder W1. The third transmission is transmitted by the third TRP, and the third transmission is precoded by the third TRP using a second, separate precoder W2 for the third TRP only.

Referring to FIG. 8, FIG. 8 is a block diagram of an example of UE CSI reporting indications for reporting configurations of mixed type joint transmissions according to one or more aspects. As described above, a UE, such as UE 115, may determine which configuration or configurations of NCJT and CJT to report in a CSI report to enable a network to more actually precode the mixed mode joint transmission. As an example, the UE reports measurement information, precoding information, channel quality information, rank information, etc. corresponding to or indicating one or more configuration or configurations of NCJT and CJT.

When reporting information for one or more configurations (or combinations) of NCJT and CJT, the UE may be configured to report all configurations (e.g., all of the different potential combinations of NCJT and/or CJT for each active transmit point and for each layer). As the amount of transmit points or layers increase, the amount of configurations/combinations can greatly increase (multiplicatively). In some implementations, the UE may use multiple CSI reports to report all of the different combinations. Alternatively, the UE may be configured to indicate a subset of the configurations, that is a subset of combinations of the potential combinations. The indication of which subset to measure and/or report may be UE determined or network indicated. When network indicated, the subset of combinations to report may be explicitly indicated, such as by a bitmap or indication to information in a data structure, or may be implicitly indicated by using other information, such as CSI-RS resource information as described further below.

When reporting all combinations, the UE may report all the combinations in one report in some implementations. Alternatively, in other implementations, such as where all combinations or information for all combinations cannot fit in one report due to bandwidth constraints the UE may systematically report all combinations over multiple reports.

As an illustrative example, the UE may go through the following list or steps in order to measure and/or report precoding information for all combinations or for prioritizing or ranking combinations. The UE may first report precoding information assuming all TRPs are on, and then reduce the active TRPs and report precoding information for less than all TRPs active. For example, when 4 TRPs are configured, the UE may measure and report information assuming 4 TRPs are all on.

In a particular implementation, the UE may report precoding information for the following combinations when all TRPs are active. The UE may first report precoding information for the combination of NCJT for all TRPs and no precoding information for CJT (e.g., NCJT across TRPs A, B, C, and D.

Second, the UE may report precoding information for combinations where only two TRPs are in CJT, the rest (other two TRPs) are transmitting NCJT (e.g., {A,B}, C, D; {A,C}, B, D; {A,D}, C, B; {B,C}, A, D; {B,D}, A, C; {C,D} A, B, where brackets indicate CJT).

Third, the UE may report precoding information for combinations where pairs of CJT are used, such as two first TRPs are CJT and two second TRPs are CJT and the pairs of TRPs are NCJT with each other (e.g., {A,B}, {C,D}; {A,C}, {B,D}; {A,D}, {C,B}; {B,C}, {A,D}; {B,D}, {A,C}; {C,D} {A,B})

Fourth, the UE may report precoding information for combinations where three TRPs are performing CJT, the rest (e.g., one TRP) performs NCJT with the CJT group (e.g., {A,B,C}, D; {A,B,D}, C; {A,C,D}, B; {B,C,D}, A).

Then, the UE may measure and/or report precoding information with less than all active TRPs. For example, the UE may shut down one TRP and go through all possible combinations as described above reporting combinations of mixture of CJT and NCJT for the remaining three active TRPs. After the combination are reported for each configuration of three active TRPS (ABC, ABD, ACD, BCD, etc.), the UE may then report precoding information for combinations where two TRPs are inactive. For example, the UE shuts down two TRPs (enumerate all combinations), reduce to two TRPs, then enumerate all possible combinations of mixture of CJT and NCJT for remaining two TRPs. The above list or order is only one non-limiting illustrative example for illustrative purposed. Other orders may be used in other implementations.

In other implementations, the UE may alternatively report a reduced number of combinations. For example, when the UE is configured to report less than all combinations, the UE may report a subset of the combinations based on a ranking or priority of information. To illustrate, the UE may report NCJT information only, and the network may be able to make estimations or inferences for various CJT transmissions and configurations of NCJT and CJT based on the NCJT information. As another illustration, the UE may report CJT information only, and the network may be able to make estimations or inferences for various NCJT transmission and configurations of NCJT and CJT based on the CJT information.

Although the UE 115 may report less than all, such as a subset, of the combinations, the UE may still measure more combinations than it reports, and in a particular implementation may measure all potential/hypothetical combinations. Alternatively, with either reporting method, the UE 115 may measure less combinations than it reports and may estimate or synthetically generate report information for more or all combinations based on a smaller set of measured combinations to reduce processing time, complexity, power, etc.

The network may reduce the number of reported combinations to reduce overhead in a multitude of different ways. As illustrative, non-limiting examples, the UE may autonomously determine (i.e., determine independent of network indication) which combinations to report (or which to not report) or the UE may determine which combinations to report (or which to not report) based on network indication. In implementations where the network provides an indication, the indication may be implicit or explicit. For example, the indication may be explicitly and included in a signaling message, such as by RRC/MAC-CE/DCI. The explicit indication may directly or indirectly indicate the combinations, such as by listing them in the message with a bitmap, or by using an indicator which points to a set of combinations in a data structure (e.g., table) stored at the UE. For example, NW indicate UE should assume the configuration of FIG. 6B, CJT for {TRP A, B}, CJT for {TRP C, D}, while NCJT between {TRP A,B} and {TRP C,D}.

For implicit indications, the UE may utilize one or more indicators or pieces of information from the network to attempt to assume, estimate, or identify which combinations to report. In some implementations, the network may use CSI resources to implicitly indicate which configurations to report or the UE may use the CSI resources to implicitly determine or assume which configurations to report. For example, CSI resource port information for configured CSI resources for the TRPs or TCI states may be used. To illustrate, when TRPs (TCI states) are configured CSI-RS ports on separate CSI-RS resources, NCJT is assumed or applied on those TRPs. Alternatively, when TRPs (TCI states) are configured on (i.e., share) with one or more CSI-RS ports on a same CSI-RS resource, CJT is assumed or applied on those TRPs.

An illustrative, non-limiting example of CSI-RS port configuration is depicted in FIG. 8. In the example of FIG. 8. TRP A and B are configured with CSI-RS ports on a same CSI-RS resource (e.g. CSI-RS resource 1), TRP C is configured with CSI-RS ports on a second CSI-RS resource, and TRP D is configured with CSI-RS ports on a third CSI-RS resource. The network may indicate that the network is planning to transmit a joint transmission including a coherent joint transmission or portion between TRP A and TRP B, which is non-coherently joint transmitted with transmissions from TRP C and TRP D (e.g., CJT between {TRP A,B} and NCJT between {TRP A,B}, TRP C, TRP D) based on the arrangement or grouping of CSI-RS ports and/or resources.

The UE may then determine the arrangement or grouping CSI-RS ports and/or resources for the TRPs based on the CSI-RE resource configuration. The UE may then measure and/or report the specific combination of mixed mode joint transmission to the network, here being measurement information for coherent joint transmissions between TRP A and TRP and measurement information for non-coherent joint transmission between TRP A/B, TRP C, and TRP D. The measurement or report information may include or correspond to precoding information (PMI), channel quality information (CQI), or both.

As an illustrative example, the UE may report first (e.g., joint) precoding information (joint W1) for TRP A and TRP B, second precoding information (W2) for TRP C, and second precoding information (W3) for TRP D. Additionally, or alternatively, the UE may report first (e.g., joint) channel quality information (joint CQI1) for TRP A and TRP B, second precoding information (CQI2) for TRP C, and second precoding information (CQI3) for TRP D.

In the above example, the notation of W1, W2, and W3 were used for the precoding information. The notations of W1-W3 are simplified notations and may represent a larger or compound matrix or matrix product. For example, W1 may include a first matrix for TRP A transposed with a second matrix for TRP [WTRPA′, WTRPB′]\hat{ }T and CQI′ based on TRPA+TRPB. This precoding information may be used to generate W1, W2, and W3 for use by the network. Alternatively, the precoding information may indicate or include one or more W, W1, W2, and W3.

A CSI-RS resource may include a single port or a plurality of ports. As illustrative examples of plurality of ports, the CSI-RS resource may include 2 ports, 4 ports, 6, ports, 8 ports, 12 ports, 16 ports, 32 ports, etc.

A CSI-RS port may include or correspond to a specific combination of time-frequency resources, such as a symbol in the time domain or a RE in the frequency domain. In some implementations, multiple CSI-RS ports can be mapped to the same time-frequency resources using multiplexing (e.g., code division multiplexing (CDM)) to distinguish between two CSI-RS ports on the same resource.

Although the specific implementations were provided and described with respect to combinations/configurations of NCJT and CJT and precoding information and CQI, in other implementations other information or indications can be provided by CSI reports. For example, the network may indicate or the UE may determine or assume an amount of layers to use. For example, the rank indicator may indicate a number of layer to use.

In some implementations, the UE or the network may determine to use two transmit points, such as two TRPs. As described above, the two TRPs may be part of the same base station or different base stations. Additionally, the two TRPs may be co-located or at separate locations. When using two TRPs, the amount of combinations/configurations of NCJT and CJT is reduced and may be of an amount where the UE can report all combinations without having to omit information or combinations. For example, the UE can report CSI report information for both options, NCJT between TRP1 and TRP2 and CJT between TRP1 and TRP2. To illustrate, the UE reports a CSI report include precoder information for the first and second TRPs alone and a precoder information for the two TRPs together. As an illustrative example, the CSI report includes precoder information W1 & CQI1 based on TRP1, report CSI includes precoder W2 & CQI2 based TRP 2, and report CSI includes joint precoder [W1′, W2′]\hat{ }T and CQI′ based on TRP1+TRP2.

Alternatively, the UE may report a subset of combinations autonomously, such as independent of network indication. For example, the UE may only report the highest performing TRP for NCJT. As an illustrative example, the CSI report includes W1 & CQI1 based on a better TRP between {TRP1, TRP2} and an indication for which TRP it is (e.g., TRP index) and the UE also reports joint precoder [W1′, W2′]\hat{ }T & CQI′ for TRP1+TRP2. As compared to the above example, the UE does not include precoder information from one of the two TRPs for NCJT.

As another alternative, the NW may indicate or configure the UE to report CSI based on a subset of combination which may be configured in advance or implicitly or explicitly indicated dynamically, such as by DCI or MAC CE. For example, the network may indicate to the UE NCJT only, CJT only, and/or mixed. When mixed, the network may indicate which NCJT to transmit, such as either for TRP1 or TRP 2.

As an illustrative example, the UE report CSI including precoder information for TRP 2 (W2 & CQI2 based TRP 2) where TRP 2 was indicated or configured by the network. The UE may additionally include joint precoding information for TRP 1 and TRP2. To illustrate, the CSI report further include joint precoder information for TRP 1 and TRP, joint precoder [W1′, W2′]\hat{ }T. CQI′ based on TRP1+TRP2.

Although indicated in the above examples as W1 or W2, the CSI report may include a precoding matrix identifier (PMI) also referred to as precoding matrix indicator or indicator information for a Type 1 report or mode or may include precoding coefficients for a Type 2 report or mode. The PMI or coefficients may indicate or otherwise allow the network to determine W1, W2, or both.

The description of the above example in FIG. 8 is with respect to a single layer of a channel for clarity and simplicity. When multiple layers are used, such information may be reported per layer. For example, when two channels with two TRPs are used, the configurations are multiplied by two or the amount of layers. Thus, the four configurations of a particular layer are multiplied by two to get 8 configurations. The four configurations may include TRP1 alone, TRP 2 alone, TRP 1 and 2 NCJT and TRP 1 and 2 CJT, with the first two configurations not being a mixed mode transmission themselves unless multiple layers are used.

Although a single layer example is illustrated above for clarity and simplicity, in other implementations, the UE may report CSI information for multiple channels. In such implementations where multiple layers, the amount of combinations may increase substantially to an amount that reporting all combinations may cause signaling overhead to outweigh the benefit of mixed mode joint transmission. Thus, measuring and/or reporting subsets of combinations may reduce this overhead.

With respect to a two TRP use case, the UE may utilize a different scheme than for more than two TRPs. For example, the UE may determine to report all combinations or to determine which subset of combinations to use based on a UE side decision (e.g., UE selection criteria), while the UE determines which combinations to report based on network indication for more than two TRPs. As another example, the UE may determine to report all combinations for two TRPs and may determine itself which subset of combinations to report for more than two TRPs. Additionally, the UE may utilize multiple different measuring and/or reporting schemes for different amounts of TRPs, amounts of layers, combinations, etc.

Thus, in the example in FIG. 8, a wireless network may indicate or otherwise enable of reporting of CSI information for one or more different configurations of NCJT and CJT to be used by the network in generating and/or transmitting a joint transmission.

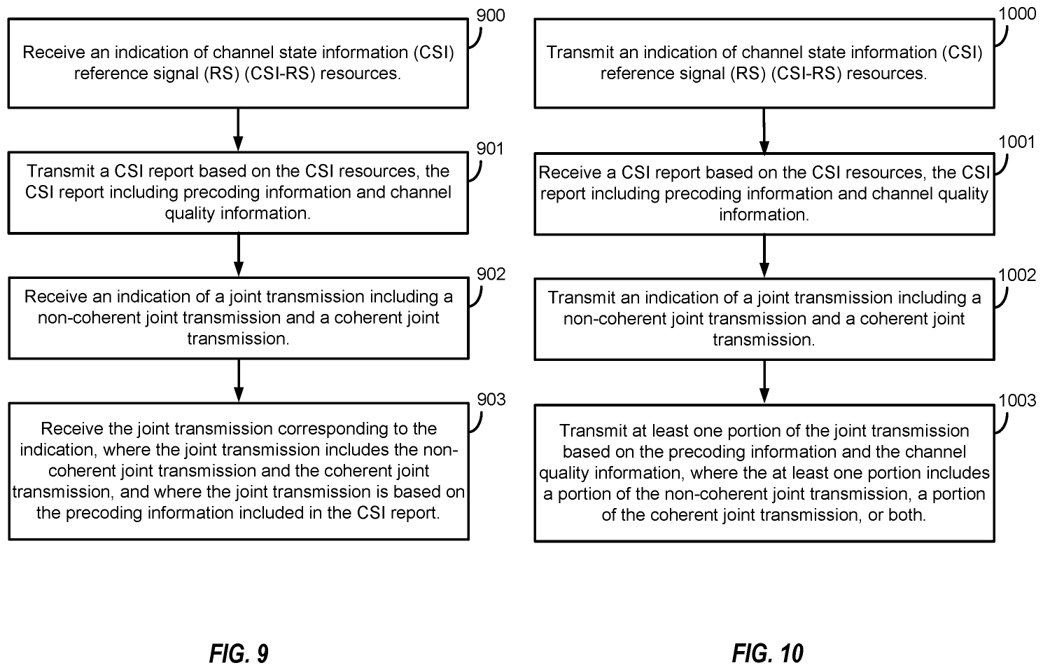

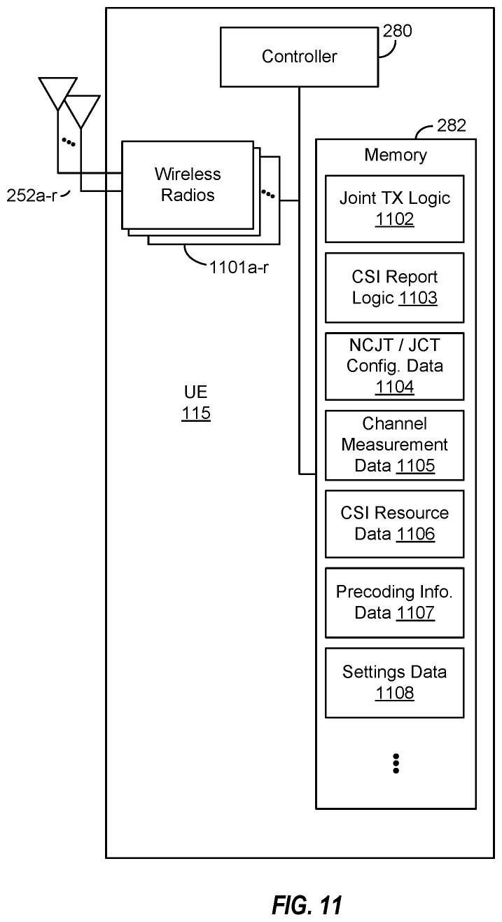

FIG. 9 is a flow diagram illustrating example blocks executed by a wireless communication device (e.g., a UE or base station) configured according to an aspect of the present disclosure. The example blocks will also be described with respect to UE 115 as illustrated in FIG. 11. FIG. 11 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1101a-r and antennas 252a-r. Wireless radios 1101a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 11, memory 282 stores joint transmission logic 1102, CSI report logic 1103, NCJT and CJT configuration data 1104, channel measurement data 1105, CSI resource data 1106, precoding information data 1107, and settings data 1108. The data (1102-1108) stored in the memory 282 may include or correspond to the data (406, 408, 442, and/or 444) stored in the memory 404 of FIG. 4.

At block 900, a wireless communication device, such as a UE, receives an indication of channel state information (CSI) reference signal (RS) (CSI-RS) resources. For example, the UE 115 receives the configuration transmission 450 of FIG. 4, the signaling message 452 of FIG. 4, the mixed mode message of FIG. 5, the CSI configuration message of FIG. 5, or one of the CSI signaling messages of FIG. 5, as described with reference to FIGS. 4-8. To illustrate, a receiver (e.g., receive processor 258 or receiver 412) of the UE 115 receives the configuration transmission 450 of FIG. 4 including the CSI report data 442 and/or the settings data 444 (e.g., CSI-RS resource settings), via wireless radios 1101a-r and antennas 252a-r.

At block 901, the UE 115 transmits a CSI report based on the CSI resources, the CSI report including precoding information and channel quality information. For example, the UE 115 transmits the feedback transmission 456 of FIG. 4 or one of the CSI reports of FIG. 5 to the base station 105 via transmission resources identified based on the CSI-RS resources, as described with reference to FIGS. 4 and 5. To illustrate, a transmitter (e.g., transmit processor 264 or transmitter 410) of the UE 115 transmits the one of the CSI reports of FIG. 5 via wireless radios 1101a-r and antennas 252a-r. The CSI report may include precoding information, channel quality information, or both as described with reference to FIG. 4. In some implementations, the precoding information may include precoding information for separate combinations or configurations of NCJT and CJT, as described with reference to FIGS. 4-8. As an illustrative example, the precoding information includes first precoding information for a first NCJT and CJT configuration, such as in FIG. 6A, and second precoding information for a second NCJT and CJT configuration, such as in FIG. 6B. The UE 115 may determine or identify which configurations to measure, report, or both, based on the CSI-RS resources, as described with reference to FIGS, 4, 5, and 8.

At block 902, the UE 115 receives an indication of a joint transmission including a non- coherent joint transmission and a coherent joint transmission. For example, the UE 115 receives the indication in the signaling message 452 of FIG. 4 or in one of the joint transmission signal message of FIG. 5, as described with reference to FIGS. 4 and 5. To illustrate, a receiver (e.g., receive processor 258 or receiver 412) of the UE 115 receives the signaling message 452 via wireless radios 1101a-r and antennas 252a-r including the indication a joint transmission. In some implementations, the indication or signaling message further schedules the joint transmission, such as identifies the transmission resources to be used for transmission of the joint transmission. Additionally, or alternatively, the indication or signaling message identifies a configuration (e.g., NCJT and CJT configuration) of the joint transmission. For example, the indication or signaling message may identify or enable the UE 115 to identify which transmissions and/or transmit points are coherent and which are non-coherent.

At block 903, the UE 115 receives the joint transmission corresponding to the indication, where the joint transmission includes the non-coherent joint transmission and the coherent joint transmission, and wherein the joint transmission is based on the precoding information included in the CSI report. For example, the UE 115 receives the joint transmission 454 (including 454A-454C) of FIG. 4, one of the joint transmissions of FIG. 5, one of the joint transmissions of any of FIGS. 6A-6C, or the joint transmission of FIGS. 7A-7C, as described with reference to FIGS. 4-7C. To illustrate, a receiver (e.g., receive processor 258 or receiver 412) of the UE 115 receives the joint transmission 454 via wireless radios 1101a-r and antennas 252a-r where the joint transmission 454 is a mixed type transmission which includes non-coherent and coherent joint transmissions.

The wireless communication device (e.g., UE or base station) may execute additional blocks (or the wireless communication device may be configured further perform additional operations) in other implementations. For example, the wireless communication device (e.g., the UE 115) may perform one or more operations described above. As another example, the wireless communication device (e.g., the UE 115) may perform one or more aspects as presented below.

In a first aspect, the non-coherent joint transmission comprises one or more transmissions associated with different transmission configuration indicator (TCI) states, wherein each respective transmission of the one or more transmissions of the non-coherent joint transmission is based on respective precoding information of the precoding information included in the CSI report, and wherein the coherent joint transmission comprises two or more transmissions with different TCI states, wherein each respective transmission of the two or more transmissions of the coherent joint transmission is based on respective joint precoding information of the precoding information included in the CSI report.

In a second aspect, alone or in combination with the first aspect, receiving the joint transmission includes: receiving the coherent joint transmission including a first transmission and a second transmission from first and second transmit points, wherein the first transmission and the second transmission are based on first precoding information corresponding to a joint precoder; and receiving a third transmission of the joint transmission from a third transmit point, wherein the third transmission is based on second precoding information corresponding to a precoder different from the joint precoder, wherein the non-coherent joint transmission includes the coherent joint transmission and the third transmission.

In a third aspect, alone or in combination with one or more of the above aspects, the precoding information of the CSI report includes the first precoding information and the second precoding information.

In a fourth aspect, alone or in combination with one or more of the above aspects, receiving the joint transmission includes receiving the non-coherent joint transmission on a first layer of a channel of the joint transmission; and receive the coherent joint transmission on a second layer of the channel of the joint transmission.

In a fifth aspect, alone or in combination with one or more of the above aspects, receiving the joint transmission include receiving the joint transmission from at least three transmit points, wherein each respective transmit point of the at least three transmit points is associated with a respective transmission configuration indicator (TCI) state.

In a sixth aspect, alone or in combination with one or more of the above aspects, each respective TCI state is the same or different.

In a seventh aspect, alone or in combination with one or more of the above aspects, the non-coherent joint transmission partially or fully overlaps with the coherent joint transmission.

In an eighth aspect, alone or in combination with one or more of the above aspects, receiving the joint transmission includes: receiving the joint transmission on one or more overlapping resources, wherein the one or more overlapping resources include one or more time resources, one or more frequency resources, one or more spatial resources, or a combination thereof.

In a ninth aspect, alone or in combination with one or more of the above aspects, the joint transmission includes a mixture of the non-coherent joint transmission and the coherent joint transmission at a transmit point level, and wherein each layer of a channel of the joint transmission has a same configuration of non-coherent and coherent joint transmissions.

In a tenth aspect, alone or in combination with one or more of the above aspects, the joint transmission includes a mixture of the non-coherent joint transmission and the coherent joint transmission at a MIMO layer level, and wherein a first layer of a channel of the joint transmission has a first configuration of non-coherent and coherent joint transmissions different from a second configuration of non-coherent and coherent joint transmissions of a second layer of the channel.

In an eleventh aspect, alone or in combination with one or more of the above aspects, the joint transmission includes a first quantity of transmissions for the first layer and includes a second quantity of transmissions for the second layer, wherein the first quantity is different from the second quantity.

In a twelfth aspect, alone or in combination with one or more of the above aspects, the transmissions of the first quantity of transmissions of the first layer have the same power level as the transmissions of the second quantity of transmissions of the second layer.

In a thirteenth aspect, alone or in combination with one or more of the above aspects, the precoding information comprises precoding matrix identifier information or precoding coefficient information.

In a fourteenth aspect, alone or in combination with one or more of the above aspects, one of: the CSI report is a CSI type 1 report, wherein the precoding information comprises precoding matrix identifier information; or the CSI report is a CSI type 2 report, wherein the precoding information comprises precoding coefficient information.

In a fifteenth aspect, alone or in combination with one or more of the above aspects, the channel quality information comprises channel quality indicator (CQI) information.

In a sixteenth aspect, alone or in combination with one or more of the above aspects, the precoding information includes first precoding information associated with a first transmit point and second precoding information associated with a second transmit point.

In a seventeenth aspect, alone or in combination with one or more of the above aspects, the precoding information includes first precoding information associated with precoding for a first potential configuration of non-coherent and coherent joint transmissions and, and second precoding associated with precoding for a second potential configuration of non-coherent and coherent joint transmissions.

In an eighteenth aspect, alone or in combination with one or more of the above aspects, the first precoding information associated with precoding for the first potential configuration corresponds to a configuration of non-coherent and coherent joint transmissions of the joint transmission.

In a nineteenth aspect, alone or in combination with one or more of the above aspects, the network node (e.g., UE 115) reports each configuration of multiple potential configurations of non-coherent and coherent joint transmissions and reports the multiple potential configurations over multiple CSI reports.

In a twentieth aspect, alone or in combination with one or more of the above aspects, the network node (e.g., UE 115): generates measurement information for a subset of configurations of multiple potential configurations of non-coherent and coherent joint transmission, wherein the precoding information and the channel quality information is based on the measurement information.

In a twenty-first aspect, alone or in combination with one or more of the above aspects, the network node (e.g., UE 115) receives an indication for a particular subset of configurations of multiple potential configurations of non-coherent and coherent joint transmissions; and performs measurement operations on the particular subset of combinations to generate measurement information, wherein the precoding information and the channel quality information are generated based on the measurement information.

In a twenty-second aspect, alone or in combination with one or more of the above aspects, the indication is an explicit value, and the explicit value indicates the particular subset of configurations to measure, report, or both.

In a twenty-third aspect, alone or in combination with one or more of the above aspects, the indication is implicit, and the network node (e.g., UE 115): determines the indication of based on CSI-RS port information and configured CSI-RS resource information, wherein an association between the CSI-RS port information and the configured CSI-RS resource information indicates the particular subset of configurations.

Accordingly, wireless communication devices may perform enhanced joint transmission operations for wireless communication devices. By performing enhanced joint transmission operations throughput can be increased and latency can be reduced.

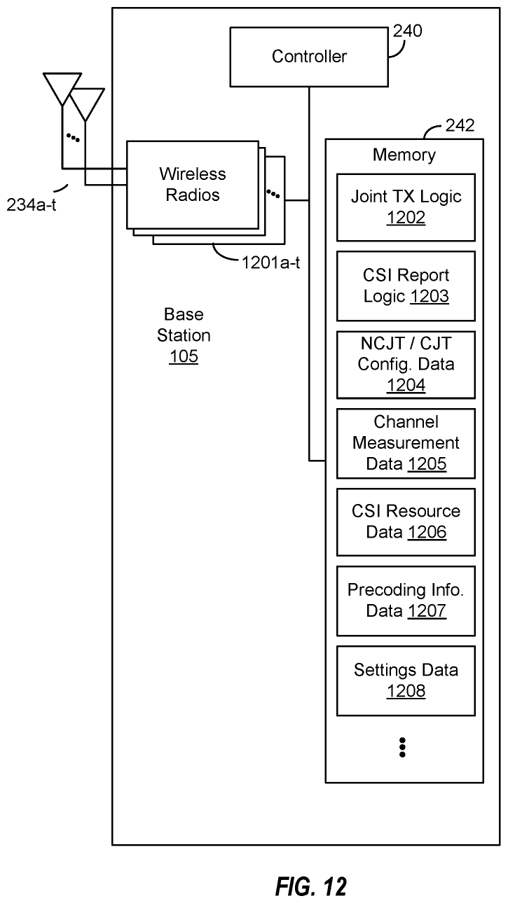

FIG. 10 is a flow diagram illustrating example blocks executed wireless communication device (e.g., a UE or network entity, such as a base station) configured according to an aspect of the present disclosure. The example blocks will also be described with respect to base station 105 as illustrated in FIG. 12. FIG. 12 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1201a-t and antennas 234a-t. Wireless radios 1201a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 12, memory 242 stores joint transmission logic 1202, CSI report logic 1203, NCJT and CJT configuration data 1204, channel measurement data 1205, CSI resource data 1206, precoding information data 1207, and settings data 1208. The data (1202-1208) stored in the memory 242 may include or correspond to the data (406, 408, 442, and/or 444) stored in the memory 432 of FIG. 4.

At block 1000, a wireless communication device, such as a network device (e.g., a base station 105), transmits an indication of channel state information (CSI) reference signal (RS) (CSI-RS) resources. For example, the base station 105 transmits the configuration transmission 450 of FIG. 4, the signaling message 452 of FIG. 4, the mixed mode message of FIG. 5, the CSI configuration message of FIG. 5, or one of the CSI signaling messages of FIG. 5, as described with reference to FIGS. 4-8. To illustrate, a transmitter (e.g., transmit processor 220/TX MIMO processor 230 or transmitter 434) of the base station 105 transmits the configuration transmission 450 of FIG. 4 including the CSI report data 442 and/or the settings data 444 (e.g., CSI-RS resource settings), via wireless radios 1201a-t and antennas 234a-t.

At block 1001, the wireless communication device receives a CSI report based on the CSI resources, the CSI report including precoding information and channel quality information. For example, the base station 105 receives the feedback transmission 456 of FIG. 4 or one of the CSI reports of FIG. 5 to the base station 105 via transmission resources identified based on the CSI-RS resources, as described with reference to FIGS. 4 and 5. To illustrate, a receiver (e.g., receive processor 258, MIMO detector 236, or receiver 436) of the base station 105 receives one of the CSI reports of FIG. 5, via wireless radios 1201a-t and antennas 234a-t. The CSI report may include precoding information, channel quality information, or both as described with reference to FIG. 4. In some implementations, the precoding information may include precoding information for separate combinations or configurations of NCJT and CJT, as described with reference to FIGS. 4-8. As an illustrative example, the precoding information includes first precoding information for a first NCJT and CJT configuration, such as in FIG. 6A, and second precoding information for a second NCJT and CJT configuration, such as in FIG. 6B. The base station 105 may identify which configurations the UE 115 is to measure, report, or both, based on the CSI-RS resources, as described with reference to FIGS, 4, 5, and 8.

At block 1002, the wireless communication device transmits an indication of a joint transmission including a non-coherent joint transmission and a coherent joint transmission. For example, the base station 105 transmits the indication in the signaling message 452 of FIG. 4 or in one of the joint transmission signal message of FIG. 5, as described with reference to FIGS. 4 and 5. To illustrate, a transmitter (e.g., transmit processor 220/TX MIMO processor 230 or transmitter 434) of the base station 105 transmits the signaling message 452 including the indication a joint transmission, via wireless radios 1201a-t and antennas 234a-t for transmitting a set of the burst transmission.

At block 1003, the wireless communication device transmits at least one portion of the joint transmission based on the precoding information and the channel quality information, where the at least one portion includes a portion of the non-coherent joint transmission, a portion of the coherent joint transmission, or both. For example, the base station 105 transmits at least one of transmissions 454A-454C of the joint transmission 454 of FIG. 4, one of the joint transmissions of FIG. 5, one of the joint transmissions of any of FIGS. 6A-6C, or the joint transmission of FIGS. 7A-7C, as described with reference to FIGS. 4-7C. To illustrate, a transmitter (e.g., transmit processor 220/TX MIMO processor 230 or transmitter 434) of the base station 105 transmits at least one of transmissions 454A-454C of the joint transmission 454, via wireless radios 1201a-t and antennas 234a-t, where the joint transmission 454 is a mixed type transmission which includes non-coherent and coherent joint transmissions.

The wireless communication device (e.g., such as a UE or base station) may execute additional blocks (or the wireless communication device may be configured further perform additional operations) in other implementations. For example, the wireless communication device may perform one or more operations described above. As another example, the wireless communication device may perform one or more aspects as described with reference to FIGS. 4-9.

In a first aspect, transmitting the at least one portion of the joint transmission includes: precoding precode a first transmission and a second transmission of the joint transmission based on first precoding information of the precoding information, wherein the first precoding information corresponds to a joint precoder; and precoding a third transmission of the joint transmission based on second precoding information of the precoding information, the second precoding information different from the first precoding information.

In a second aspect, alone or in combination with the first aspect, transmitting the at least one portion of the joint transmission includes: transmitting the non-coherent joint transmission on a first layer of a channel of the joint transmission; and transmitting the coherent joint transmission on a second layer of the channel of the joint transmission.

In a third aspect, alone or in combination with one or more of the above aspects, the non-coherent joint transmission has a first transmission configuration indicator (TCI) state different from a second TCI state of the coherent joint transmission.

In a fourth aspect, alone or in combination with one or more of the above aspects, the non-coherent joint transmission comprises one or more transmissions associated with different transmission configuration indicator (TCI) states, wherein each respective transmission of the one or more transmissions of the non-coherent joint transmission is based on respective precoding information of the precoding information included in the CSI report, and wherein the coherent joint transmission comprises two or more transmissions with different TCI states, wherein each respective transmission of the two or more transmissions of the coherent joint transmission is based on respective joint precoding information of the precoding information included in the CSI report.

In an additional aspects a method of wireless communication includes transmitting, by a wireless communication network, an indication of a joint transmission including a non-coherent joint transmission and a coherent joint transmission; transmitting, by the wireless communication network, a first transmission from a first transmit point; transmitting, by the wireless communication network, a second transmission from a second transmit point, the first and second transmissions coherent joint transmitted; and transmitting, by the wireless communication network, a third transmission from a third transmit point, the third transmission non-coherent joint transmitted with the first and second transmissions.

Accordingly, wireless communication devices may perform enhanced joint transmission operations for wireless communication devices. By performing enhanced joint transmission operations throughput can be increased and latency can be reduced.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network node for wireless communication, comprising:
at least one processor; and
a memory coupled to the at least one processor,
wherein the at least one processor is configured to:
receive an indication of channel state information (CSI) reference signal (RS) (CSI-RS) resources;
transmit a CSI report based on the CSI resources, the CSI report including precoding information and channel quality information;
receive an indication of a joint transmission including a non-coherent joint transmission and a coherent joint transmission; and
receive the joint transmission corresponding to the indication, wherein the joint transmission includes the non-coherent joint transmission and the coherent joint transmission, and wherein the joint transmission is based on the precoding information included in the CSI report.

2. The network node of claim 1, wherein the non-coherent joint transmission comprises one or more transmissions associated with different transmission configuration indicator (TCI) states, wherein each respective transmission of the one or more transmissions of the non-coherent joint transmission is based on respective precoding information of the precoding information included in the CSI report, and wherein the coherent joint transmission comprises two or more transmissions with different TCI states, wherein each respective transmission of the two or more transmissions of the coherent joint transmission is based on respective joint precoding information of the precoding information included in the CSI report.

3. The network node of claim 1, wherein, to receive the joint transmission, the at least one processor is configured to:
receive the coherent joint transmission including a first transmission and a second transmission from first and second transmit points, wherein the first transmission and the second transmission are based on first precoding information corresponding to a joint precoder; and
receive a third transmission of the joint transmission from a third transmit point, wherein the third transmission is based on second precoding information corresponding to a precoder different from the joint precoder, wherein the non-coherent joint transmission includes the coherent joint transmission and the third transmission.

4. The network node of claim 3, wherein the precoding information of the CSI report includes the first precoding information and the second precoding information.

5. The network node of claim 1, wherein, to receive the joint transmission, the at least one processor is configured to:
receive the non-coherent joint transmission on a first layer of a channel of the joint transmission; and
receive the coherent joint transmission on a second layer of the channel of the joint transmission.

6. The network node of claim 1, wherein, to receive the joint transmission, the at least one processor is configured to receive the joint transmission from at least three transmit points, wherein each respective transmit point of the at least three transmit points is associated with a respective transmission configuration indicator (TCI) state.

7. The network node of claim 6, wherein each respective TCI state is the same or different.

8. The network node of claim 1, wherein the non-coherent joint transmission partially or fully overlaps with the coherent joint transmission.

9. The network node of claim 8, wherein, to receive the joint transmission, the at least one processor is configured to:
receive the joint transmission on one or more overlapping resources, wherein the one or more overlapping resources include one or more time resources, one or more frequency resources, one or more spatial resources, or a combination thereof.

10. The network node of claim 1, wherein the joint transmission includes a mixture of the non-coherent joint transmission and the coherent joint transmission at a transmit point level, and wherein each layer of a channel of the joint transmission has a same configuration of non-coherent and coherent joint transmissions.

11. The network node of claim 1, wherein the joint transmission includes a mixture of the non-coherent joint transmission and the coherent joint transmission at a MIMO layer level, and wherein a first layer of a channel of the joint transmission has a first configuration of non-coherent and coherent joint transmissions different from a second configuration of non-coherent and coherent joint transmissions of a second layer of the channel.

12. The network node of claim 11, wherein the joint transmission includes a first quantity of transmissions for the first layer and includes a second quantity of transmissions for the second layer, wherein the first quantity is different from the second quantity.

13. The network node of claim 12, wherein the transmissions of the first quantity of transmissions of the first layer have the same power level as the transmissions of the second quantity of transmissions of the second layer.

14. The network node of claim 1, wherein the precoding information comprises precoding matrix identifier information or precoding coefficient information.

15. The network node of claim 1, wherein one of:
the CSI report is a CSI type 1 report, wherein the precoding information comprises precoding matrix identifier information; or
the CSI report is a CSI type 2 report, wherein the precoding information comprises precoding coefficient information.

16. The network node of claim 1, wherein the channel quality information comprises channel quality indicator (CQI) information.

17. The network node of claim 1, wherein the precoding information includes first precoding information associated with a first transmit point and second precoding information associated with a second transmit point.

18. The network node of claim 1, wherein the precoding information includes first precoding information associated with precoding for a first potential configuration of non-coherent and coherent joint transmissions and, and second precoding associated with precoding for a second potential configuration of non-coherent and coherent joint transmissions.

19. The network node of claim 18, wherein the first precoding information associated with precoding for the first potential configuration corresponds to a configuration of non-coherent and coherent joint transmissions of the joint transmission.

20. The network node of claim 1, wherein the at least one processor is configured to report each configuration of multiple potential configurations of non-coherent and coherent joint transmissions and to report the multiple potential configurations over multiple CSI reports.

21. The network node of claim 12, wherein the at least one processor is configured to:
generate measurement information for a subset of configurations of multiple potential configurations of non-coherent and coherent joint transmission, wherein the precoding information and the channel quality information is based on the measurement information.

22. The network node of claim 1, wherein the at least one processor is configured to:
receive an indication for a particular subset of configurations of multiple potential configurations of non-coherent and coherent joint transmissions; and
perform measurement operations on the particular subset of combinations to generate measurement information, wherein the precoding information and the channel quality information are generated based on the measurement information.

23. The network node of claim 22, wherein the indication is an explicit value, wherein the explicit value indicates the particular subset of configurations to measure, report, or both.

24. The network node of claim 22, wherein the indication is implicit, and wherein the at least one processor is further configured to:
determine the indication based on CSI-RS port information and configured CSI-RS resource information, wherein an association between the CSI-RS port information and the configured CSI-RS resource information indicates the particular subset of configurations.

25. The network node of claim 1, wherein the CSI-RS resources indicate CSI-RS port information and configured CSI-RS resource information, and wherein the at least one processor is configured to:
determine a first transmit point and a second transmit point are configured with first CSI-RS ports on a first CSI-RS resource based on the CSI-RS port information and the configured CSI-RS resource information;
determine to report first precoding information of the precoding information for the first and second transmit points based on the first and second transmit points being configured with CSI-RS ports on a same CSI-RS resource;
determine a third transmit point is configured with second CSI-RS ports on a second CSI-RS resource different from the first CSI-RS resource based on the CSI-RS port information and the configured CSI-RS resource information; and
determine to report second precoding information of the precoding information for the third transmit point based on the third transmit point being configured with CSI-RS ports on a different CSI-RS resource than the first and second transmit points.

26. A network node for wireless communication, comprising:
at least one processor; and
a memory coupled to the at least one processor,
wherein the at least one processor is configured to:
transmit an indication of channel state information (CSI) reference signal (RS) (CSI-RS) resources;
receive a CSI report based on the CSI resources, the CSI report including precoding information and channel quality information;
transmit an indication of a joint transmission which includes a non-coherent joint transmission and a coherent joint transmission; and
transmit at least one portion of the joint transmission based on the precoding information and the channel quality information, wherein the at least one portion includes a portion of the non-coherent joint transmission, a portion of the coherent joint transmission, or both.

27. The network node of claim 26, wherein, to transmit at least one portion of the joint transmission, the at least one processor is configured to:
precode a first transmission and a second transmission of the joint transmission based on first precoding information of the precoding information, wherein the first precoding information corresponds to a joint precoder; and
precode a third transmission of the joint transmission based on second precoding information of the precoding information, the second precoding information different from the first precoding information.

28. The network node of claim 26, wherein, transmit at least one portion of the joint transmission, the at least one processor is configured to:
transmit the non-coherent joint transmission on a first layer of a channel of the joint transmission; and
transmit the coherent joint transmission on a second layer of the channel of the joint transmission.

29. The network node of claim 28, wherein the non-coherent joint transmission has a first transmission configuration indicator (TCI) state different from a second TCI state of the coherent joint transmission.

30. The network node of claim 26, wherein the non-coherent joint transmission comprises one or more transmissions associated with different transmission configuration indicator (TCI) states, wherein each respective transmission of the one or more transmissions of the non-coherent joint transmission is based on respective precoding information of the precoding information included in the CSI report. and wherein the coherent joint transmission comprises two or more transmissions with different TCI states, wherein each respective transmission of the two or more transmissions of the coherent joint transmission is based on respective joint precoding information of the precoding information included in the CSI report.
